(19) United States
(12) Patent Application Publication
(10) Pub. No.: US 2006/0257590 A1
(43) Pub. Date: Nov. 16, 2006

(54) Polazing plate and manufacturing method thereof, and image display device

(76) Inventor: Kazuhiro Nakamura, Kanagawa (JP)

Correspondence Address: BUCHANAN, INGERSOLL & ROONEY PC, POST OFFICE BOX 1404, ALEXANDRIA, VA, 22313-1404, US

(21) Appl. No.: 10/551,346

(22) PCT Filed: Mar. 25, 2004
(86) PCT No.: PCT/JP04/04188

§ 371 Date: Sep. 28, 2005

(30) Foreign Application Priority Data
Mar. 28, 2003 (JP) 2003-091770
Sep. 30, 2003 (JP) 2003-341323

(51) Int. Cl. C09K 19/00

(52) U.S. Cl. 428/1.3

(57) ABSTRACT

A method for manufacturing a polarizing plate comprising: bonding an antireflection film containing a transparent support and an antireflection structure including a plurality of layers different in refractive index each comprising a cured film to a polarizing film, wherein at least one layer of the plurality of layers different in refractive index is a layer having a higher refractive index than that of the transparent support and a thickness of 10 nm to 2 μm, and the antireflection film is bonded to the polarizing film after being subjected to a hydrophilization treatment so that a contact angle to water of a surface of the antireflection film to be bonded to the polarizing film falls within a range of 20 degrees to 50 degrees.

### TECHNICAL FIELD

The present invention relates to a polarizing plate using an antireflection film as at least one of surface protective films, and an image display device using the same.

### BACKGROUND ART

The antireflection film is positioned on the surface of a display in order to prevent contrast reduction due to reflection of external light or glaring of images in each of various image display devices such as a liquid crystal display device (LCD), a plasma display panel (PDP), an electroluminescence display (ELD) and a cathode ray tube display device (CRT). For this reason, the antireflection film is required to have high physical strengths (such as abrasion resistance), chemical resistance, and weather resistances (such as moist heat resistance and light resistance).

For antireflection layers (such as a high refractive index layer, an intermediate refractive index layer, and a low refractive index layer) to be used in the antireflection film, a multilayer film in which transparent thin films of metal oxides are stacked one on another has been widely used. The transparent thin films of metal oxides have been generally formed by a chemical vapor deposition (CVD) process or a physical vapor deposition (PVD) process, particularly, a vacuum evaporation process which is a kind of the physical vapor deposition processes.

However, the processes for forming transparent thin films of metal oxides by vapor deposition result in low productivity, and is not suitable for the mass production. Such being the case, a forming process by coating which is high in productivity has been proposed.

When the antireflection film is manufactured by coating, the high refractive index layer can be formed using a resin having a high refractive index. Alternatively, it can also be formed by dispersing inorganic fine particles having a high refractive index more finely, and introducing them into the film. The latter process is preferred in that the controllable refractive index range is wide, and in that the transparency and the physical strengths of the resulting film are superior. By introducing larger amounts of inorganic fine particles having a high refractive index into the film while keeping the finely dispersed state, a transparent high refractive index layer having a higher refractive index is formed (see, e.g., JP-A-8-110401, JP-A-8-179123, JP-A-11-153703, JP-A-2001-166104, JP-A-2001-188104, JP-A-2002-116323, and JP-A-2002-156508).

It is very effective to introduce titanium dioxide fine particles having a very high refractive index into the high refractive index layer. However, the titanium dioxide fine particles have a photocatalytic function. Therefore, when the high refractive index layer (antireflection film) is used under sunlight for a long time, the fine particles decompose organic compounds contained in the high refractive index layer, resulting in remarkable deteriorations in physical strengths and optical performances. Such a phenomenon noticeably occurs particularly in the high refractive index layer in which titanium dioxide fine particles are held in a finely dispersed state.

Therefore, it is desirable to manufacture a high refractive index layer which can be manufactured by coating, contains titanium dioxide fine particles, and is further excellent in weather resistances (particularly, light resistance). However, this requirement has not yet been satisfactorily met.

It has been found that the foregoing problem becomes noticeable by carrying out a hydrophilization treatment to be performed for laminating the film on a polarizing film comprising polyvinyl alcohol and iodine, for example, a saponification treatment by dipping the film in an alkali solution, in order to use the film as a surface protective film of the polarizing plate which is an object of the invention. This is caused because each layer forming the antireflection structure is very thin, and tends to receive effects even if it is a layer which is not a surface layer. As the effects thereof, there may be mentioned both of the following: (1) the inorganic fine particles added undergo deterioration and elution under the influence of the saponification treatment, and particularly for titanium dioxide fine particles, surface coating substances for inhibiting the photocatalytic action inherently possessed thereby are eluted in the alkali solution; and (2) a binder comprising an organic polymer for binding between titanium dioxide fine particles is hydrolyzed. These effects are noticeable in a layer containing a large amount of inorganic fine particles as a filler, particularly, a layer having a high refractive index.

Whereas, in recent years, the screen size of a liquid crystal display device (LCD) has been increasing, and liquid crystal display devices including antireflection films disposed therein have been increasing in proportion.

In a liquid crystal display device (LCD), a polarizing plate is an essential optical material. In general, it is configured such that a polarizing film is protected by two protective films. However, further provision of an antireflection film having weather resistances and antireflection function results in an increase in number of constituent layers of a display panel, and hence has a large restriction in terms of both aspects of manufacturing costs and exertion of functions. By imparting the antireflection function to the protective film of the liquid crystal display device, it is possible to expect a display device which has weather resistances, physical protective properties, and antireflection property, and implements cost reduction and thickness reduction. Accordingly, development thereof has been desired.

### DISCLOSURE OF THE INVENTION

The invention was made under the foregoing background. It is an object thereof to provide polarizing plates each with an antireflection layer excellent in physical strengths and weather resistances at a low cost and in large quantities by optimizing the conditions for a saponification treatment step essential for processing surface protective films each having the antireflection layer into the polarizing plates, and the element composition of titanium dioxide fine particles contained as an essential component in the antireflection layer. It is another object to provide an image display device subjected to an antireflection treatment by a proper means.

The foregoing objects of the invention have been achieved by the polarizing plates respectively using the antireflection films of the following constitutions (1) to (13), and the image display devices of (14) and (15).

(1) A method for manufacturing a polarizing plate comprising bonding an antireflection film having an antireflection structure formed by a plurality of layers different in refractive index each comprising a cured film over one side of a transparent support to a polarizing film, characterized in that at least one layer out of the plurality of the layers different in refractive index is a layer having a higher refractive index than that of the transparent support and a thickness of 10 nm to 2 μm, and the antireflection film is bonded to the polarizing film after being subjected to a hydrophilization treatment so that the contact angle to water of the bonding surface of the antireflection film falls within a range of 20 degrees to 50 degrees.

(2) The method for manufacturing a polarizing plate according to (1), characterized in that the hydrophilization treatment is carried out so that the contact angle falls within a range of 30 to 40 degrees.

(3) The method for manufacturing a polarizing plate according to (1) or (2), characterized in that the hydrophilization treatment is carried out so that the contact angle falls within a range of 40 to 50 degrees.

(4) The method for manufacturing a polarizing plate according to any of (1) to (3), characterized in that the hydrophilization treatment includes a step of dipping the antireflection film in an alkali solution for saponification.

(5) A method for manufacturing a polarizing plate comprising bonding an antireflection film having an antireflection structure formed by a plurality of layers different in refractive index each comprising a cured film over one side of a transparent support to a polarizing film, characterized in that a surface of the antireflection film opposite to a surface thereof on which the antireflection structure is formed is taken as a bonding surface, and only the bonding surface is subjected to a saponification treatment so that the contact angle to water falls within a range of 10 degrees to 50 degrees.

(6) The method for manufacturing a polarizing plate according to any of (1) to (5), characterized in that the cured film forming the antireflection structure is obtained by coating, drying, and curing a coating composition containing at least one film-formable solute and at least one solvent.

(7) A method for manufacturing a polarizing plate manufactured by the method according to any of (1) to (6), characterized in that the layer forming the antireflection structure contains inorganic fine particles.

(8) A method for manufacturing a polarizing plate manufactured by the method according to (7), characterized by using the antireflection film wherein the plurality of the layers include at least one each layer of a high refractive index layer having a higher refractive index than that of the support and a low refractive index layer having a lower refractive index than that of the support, and the high refractive index layer is a constituent layer with a refractive index of 1.55 to 2.40 which contains inorganic fine particles containing titanium dioxide as a main component, and containing at least one element selected from cobalt, aluminum, and zirconium.

(9) The method for manufacturing a polarizing plate according to (8), characterized in that each of the inorganic fine particles is covered with at least one compound of an inorganic compound, an organometallic compound, and an organic compound, which reduces or destroys the photocatalytic activity.

(10) A polarizing plate characterized by having been manufactured by the manufacturing method according to any of (1) to (9).

(11) The polarizing plate according to (10), characterized in that a film other than the antireflection film out of surface protective films for forming the polarizing plate is an optical compensation film having an optical compensation layer comprising an optical anisotropic layer on a surface of the surface protective film opposite to a surface thereof to be bonded to the polarizing film, the optical anisotropic layer is a layer having a negative birefringence, and comprising a compound having a discotic structure unit, the disc plane of the discotic structure unit is inclined to the surface protective film plane, and the angle formed between the disc plane of the discotic structure unit and the surface protective film plane varies in a direction of depth of the optical anisotropic layer.

(12) A liquid crystal display device having at least one polarizing plate according to (10) or (11).

(13) The liquid crystal display device according to (12), characterized by being of TN, STN, VA, IPS, or OCB mode transmission type, reflection type, or semi-transmission type.

In accordance with the contents of this specification, an antireflection film having a high refractive index layer containing inorganic fine particles which contain at least one element selected from cobalt, aluminum, and zirconium, and contain titanium dioxide as a main component, and a low refractive index layer comprising a cured film of a copolymer comprising repeating units derived from fluorine-containing vinyl monomers, and repeating units each having a (meth)acryloyl group on the side chain is subjected to a saponification treatment under the saponification conditions described in this specification to manufacture a polarizing plate. As a result, it is possible to provide polarizing plates each having an antireflection film excellent in physical strengths and weather resistances (particularly, light resistance) as a surface protective film at a low cost and in large quantities.

Further, it is thereby possible to provide an image display device holding the foregoing features.

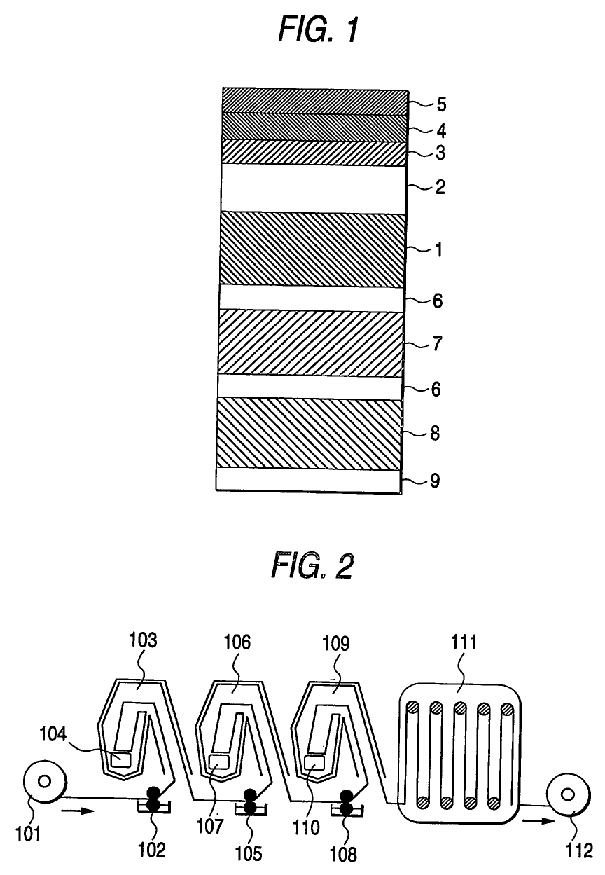

### BRIEF DESCRIPTION OF THE DRAWINGS

[FIG. 1] A schematic cross sectional view schematically showing the layer structure of a polarizing plate using an antireflection film excellent in antireflection performance as a surface protective film.

[FIG. 2] A schematic view showing one example of an apparatus for carrying out the invention.

### DESCRIPTION OF REFERENCE NUMERALS AND SIGNS

1 Transparent support
2 Hard coat layer
3 Intermediate refractive index layer
4 High refractive index layer
5 Low refractive index layer (Outermost layer)
6 Adhesive layer
7 Polarizing film
8 Surface protective film on the opposite side
9 Sticker layer.
101 Feeding out
102 First coating station
103 First drying zone
104 First UV irradiation device
105 Second coating station
106 Second drying zone
107 Second UV irradiation device
108 Third coating station
109 Third drying zone
110 Third UV irradiation device
111 Drying zone
112 Winder

Below, the invention will be described in details.

An antireflection structure of the invention includes at least one layer of low refractive index layer and at least one layer of high refractive index layer. The films forming their respective layers are cured films, each of which can be obtained by coating, drying, and curing a coating composition preferably containing at least one film-formable solute and at least one solvent. The film-formable solute herein denotes a substance to be wet coated on a base material in a state dissolved or dispersed in at least one solvent for dissolving or dispersing it therein, and to mostly remain as a film on the base material after drying of the solvent. Incidentally, in this specification, the wording “(value 1) to (value 2)” denotes “(value 1) or more and (value 2) or less”.

[Transparent Support]

Transparent supports of the antireflection films for use in the invention are preferably plastic films. The plastic films include films of cellulose esters (e.g., triacetyl cellulose, diacetyl cellulose, propionyl cellulose, butyryl cellulose, acetylpropionyl cellulose, and nitrocellulose), and polyolefins (e.g., polypropylene, polyethylene, and polymethylpentene). Triacetyl cellulose and polyolefins are preferred to be used for polarizing plates because of their small retardation and high optical uniformity. Particularly, triacetyl cellulose is preferred when it is used for a liquid crystal display device.

When the transparent support is a triacetyl cellulose film, it is preferably a triacetyl cellulose film manufactured by casting a triacetyl cellulose solution (referred to as a dope) prepared by dissolving triacetyl cellulose in a solvent with either casting method of single layer casting or multilayer co-casting.

Particularly, from the viewpoint of environmental conservation, a triacetyl cellulose film manufactured by using a triacetyl cellulose dope prepared by dissolving triacetyl cellulose in a solvent substantially not containing dichloromethane by a low-temperature dissolution method or a high-temperature dissolution method is preferred. There is a detailed description on this in Journal of Technical Disclosure (KOUKAI GIHOU) 2001—No. 1745 from Japan Institute of Invention and Innovation.

The single-layer triacetyl cellulose film is manufactured by drum casting, band casting, or the like disclosed in JP-A-7-11055, and the like, and the latter triacetyl cellulose film comprising a plurality of layers is manufactured by a so-called co-casting method disclosed in JP-A-61-94725, JP-B-62-43846, and the like.

For example, raw material flakes are dissolved in solvents such as halogenated hydrocarbons (e.g., dichloromethane), alcohols (e.g., methanol, ethanol, and butanol), esters (e.g., methyl formate, and methyl acetate), and ethers (e.g., dioxane, dioxolane, and diethyl ether). To this, were added, if required, various additives such as a plasticizer, an ultraviolet absorber, a deterioration inhibitor, a slipping agent, and a release accelerator. The resulting solution (dope) is cast on a support comprising a horizontal endless metal belt or a rotating drum with a dope feed means (referred to as a die).

For a single layer, a single dope is cast to a single layer, and for a multilayer, a low-concentration dope is co-cast in both sides of a high-concentration cellulose ester dope. The dope is then dried to a certain degree on the support to impart rigidity to the resulting film. The film is released from the support, and then passed through a drying zone with various transportation means to remove the solvents.

The foregoing solvent for dissolving triacetyl cellulose is typically dichloromethane. However, from the viewpoints of global environment and working environment, it is preferable that the solvent substantially does not contain halogenated hydrocarbon such as dichloromethane. The wording “substantially does not contain” denotes that the proportion of halogenated hydrocarbon in the organic solvent is less than 5 mass % (weight %) (preferably less than 2 mass %). When a dope of triacetyl cellulose is prepared using a solvent substantially not containing dichloromethane or the like, a specific dissolution method as described later is preferably used.

A first method is referred to as a cooling dissolution method, and will be described below. First, triacetyl cellulose is gradually added into a solvent with stirring at a temperature in the vicinity of room temperature (−10 to 40° C.). Then, the mixture is cooled to −100 to −10° C. (preferably from −80 to −10° C., more preferably from −50 to −20° C., and most preferably from —50 to −30° C.). The cooling may be performed in a dry ice/methanol bath (−75° C.) or in a cooled diethylene glycol solution (−30 to −20° C.). Such cooling causes the mixture of triacetyl cellulose and the solvent to be solidified. This is further heated to 0 to 200° C. (preferably from 0 to 150° C., more preferably from 0 to 120° C., and most preferably from 0 to 50° C.), thereby to turn into a solution where triacetyl cellulose flows in the solvent. The temperature may be elevated by only allowing the solidified mixture to stand at room temperature, or may also be elevated in a warm bath.

A second method is referred to as a high-temperature dissolution method, and will be described below. First, triacetyl cellulose is gradually added into a solvent with stirring at a temperature in the vicinity of room temperature (−10 to 40° C.). The triacetyl cellulose solution of the invention is preferably swelled in advance by adding triacetyl cellulose to a mixed solvent containing various solvents. In this method, the triacetyl cellulose is preferably dissolved to a concentration of 30 mass % or less, however, in view of the drying efficiency for film formation, the concentration is preferably as high as possible. Then, the organic solvent mixed solution is heated to 70 to 240° C. (preferably from 80 to 220° C., more preferably from 100 to 200° C., and most preferably from 100 to 190° C.) under a pressure of 0.2 MPa to 30 MPa. This heated solution cannot be coated as it is, and hence it is then required to be cooled to a temperature lower than the lowest boiling point of the solvents used. In this case, the solution is generally cooled to −10 to 50° C., and returned to normal pressure. The cooling may be performed only by allowing a high-pressure high-temperature container or piping system in which the triacetyl cellulose solution is stored to stand at room temperature. More preferably, the device may also be cooled using a refrigerant such as cooling water.

The thickness of the transparent support has no particular restriction. However, the thickness is desirably 1 to 300 μm, preferably 30 to 150 μm, particularly preferably 40 to 120 μm, and most preferably 40 to 100 μm.

The light transmittance of the transparent support is preferably 80% or more, and more preferably 86% or more. The haze of the transparent support is preferably 2.0% or less, and more preferably 1.0% or less (the term “haze” herein used is defined as having the meaning commonly given to it, and it is given as a photographic term in the Japanese Scientific Terms (Gakujyutsu Yougo Syu) issued by the Science Council on Scientific terms of Ministry of Education, Culture, Sports, Science, and Technology, and can be determined by means of a general-purpose haze meter). The refractive index of the transparent support is preferably 1.4 to 1.7. To the transparent support, an infrared absorber or an ultraviolet absorber may be added. The amount of the infrared absorber to be added is preferably 0.01 to 20 mass %, and more preferably 0.05 to 10 mass % based on the amount of the transparent support. Inert inorganic compound particles may also be added as a slipping agent to the transparent support. Examples of the inorganic compound may include SiO₂, TiO₂, BaSO₄, CaCO₃, talk, and kaolin.

[Inorganic Fine Particles]

To the high refractive index layer of the antireflection film of the invention, particles having a high refractive index for achieving a desired refractive index can be added. As such particles, mention may be made of inorganic fine particles of titanium dioxide, zirconium oxide, aluminum oxide, and the like. Out of these, titanium dioxide may be preferably used because of its particularly high refractive index. However, titanium dioxide has a photocatalytic property, and hence it is in particular preferably used in the form of inorganic fine particles containing at least one element selected from cobalt, aluminum, and zirconium, and containing titanium dioxide as a main component. The main component denotes the component of which the content (mass %) is the highest of those of the components forming the particle.

The high refractive index layer of the invention has a refractive index of 1.55 to 2.40, and it is the layer referred to as a so-called high refractive index layer or intermediate refractive index layer. However, in this specification, this layer may be generically referred to as a high refractive index layer.

The inorganic fine particles containing titanium dioxide as a main component in the invention has a refractive index of preferably 1.90 to 2.80, more preferably 2.10 to 2.80, and most preferably 2.20 to 2.80.

The primary particles of the inorganic fine particles containing titanium dioxide as a main component have a mass average diameter of preferably 1 to 200 nm, more preferably 5 to 150 nm, still more preferably 10 to 100 nm, and in particular preferably 10 to 80 nm.

The particle diameter of each inorganic fine particle can be measured by means of a light scattering method or an electron micrograph. The inorganic fine particle has a specific surface area of preferably 10 to 400 m²/g, more preferably 20 to 200 m²/g, and most preferably 30 to 150 m²/g.

In terms of crystal structure, the inorganic fine particle containing titanium dioxide as a main component contains preferably a component having a rutile, a rutile/anatase mixed crystal, anatase, or amorphous structure as a main component, and in particular preferably a component having a rutile structure as a main component. The main component denotes the component of which the content (mass %) is the highest of those of the components forming the particle.

By allowing the inorganic fine particles containing titanium dioxide as a main component to contain at least one element selected from Co (cobalt), Al (aluminum), and Zr (zirconium), it is possible to inhibit the photocatalytic activity possessed by titanium dioxide. This can improve the weather resistances of the high refractive index layer of the invention.

The particularly preferred element is Co (cobalt). These elements may also be preferably used in combination of two or more thereof.

The content of Co (cobalt), Al (aluminum), or Zr (zirconium) based on the amount of Ti (titanium) is preferably 0.05 to 30 mass %, more preferably 0.1 to 10 mass %, still more preferably 0.2 to 7 mass %, in particular preferably 0.3 to 5 mass %, and most preferably 0.5 to 3 mass % relative to the amount of Ti.

Co (cobalt), Al (aluminum), and Zr (zirconium) may be allowed to be present in at least either of the inside or the surface of each inorganic fine particle containing titanium dioxide as a main component. However, they are allowed to be preferably present in the inside of the inorganic fine particle containing titanium oxide as a main component, and most preferably present in both of the inside and the surface thereof.

Co (cobalt), Al (aluminum), and Zr (zirconium) may be allowed to be present (e.g., to be doped) in the inside of the inorganic fine particle containing titanium dioxide as a main component in various manners. For example, mention may be made of Ion Implantation Method (Vol. 18, No. 5, pp. 262 to 268, 1998; Yasushi Aoki), and the methods described in JP-A-11-263620, JP-T-11-512336 (the term “JP-T” as used herein means a published Japanese translation of a PCT patent application), EP No. 0335773, and JP-A-5-330825.

The technique for introducing Co (cobalt), Al (aluminum), and Zr (zirconium) in the particle formation process of the inorganic fine particles containing titanium dioxide as a main component, (described in, for example, JP-T-11-512336, EP No. 0335773, or JP-A-5-330825) is particularly preferred.

Co (cobalt), Al (aluminum), and Zr (zirconium) are also preferably each present in the oxide form.

The inorganic fine particles containing titanium dioxide as a main component may also further contain other elements according to the intended purpose. The other elements may be contained as impurities. Examples of the other elements may include Sn, Sb, Cu, Fe, Mn, Pb, Cd, As, Cr, Hg, Zn, Mg, Si, P, and S.

The inorganic fine particles containing titanium dioxide as a main component for use in the invention may be subjected to a surface treatment. The surface treatment thereof can more reduce or destroy the photocatalytic activity of the inorganic fine particles. The surface treatment is carried out using an inorganic compound, an organic compound, and an organometallic compound, having a function of reducing or destroying the photocatalytic activity. Examples of the inorganic compound for use in the surface treatment may include cobalt-containing inorganic compounds (such as CoO₂, CO₂O₃, and CO₃O₄), aluminum-containing inorganic compounds (such as Al₂O₃ and Al(OH)₃), zirconium-containing inorganic compounds (such as ZrO₂ and Zr(OH)₄), silicon-containing inorganic compounds (such as SiO₂), and iron-containing inorganic compounds (such as Fe₂O₃).

Cobalt-containing inorganic compounds, aluminum-containing inorganic compounds, and zirconium-containing inorganic compounds are particularly preferred. Cobalt-containing inorganic compounds, and hydroxides of Al and Zr, or combinations thereof are in particular preferably used.

Examples of the organic compound for use in the surface treatment may include polyol, alkanolamine, and stearic acid. On the other hand, examples of the organometallic compound may include a silane coupling agent and a titanate coupling agent. Out of these, the silane coupling agent is most preferred. In particular, the surface treatment is preferably carried out with an organometallic compound represented by the following formula A and a derivative thereof.
(R¹)ₘ—Si(OR²)ₙ Formula A;

In the formula A, R¹ denotes a substituted or unsubstituted alkyl group or aryl group; R² denotes a substituted or unsubstituted alkyl group or acyl group; and m denotes 0 or an integer of 1 to 3, and n denotes an integer of 1 to 4, provided that the sum of m and n is 4.

In the formula A, R¹ denotes a substituted or unsubstituted alkyl group or aryl group. As alkyl groups, mention may be made of a methyl group, an ethyl group, a propyl group, an isopropyl group, a hexyl group, a t-butyl group, a sec-butyl group, a hexyl group, a decyl group, a hexadecyl group, and the like. The number of carbons of the alkyl group represented by R¹ is 1 to 30, more preferably 1 to 16, and in particular preferably 1 to 6. As the aryl groups represented by R¹, mention may be made of a phenyl group, a naphthyl group, and the like, and preferably a phenyl group.

Although the substituent has no particular restriction, it is preferably a halogen atom (such as fluorine, chlorine, or bromine), a hydroxyl group, a mercapto group, a carboxyl group, an epoxy group, an alkyl group (such as a methyl group, an ethyl group, an i-propyl group, a propyl group, or a t-butyl group), an aryl group (such as a phenyl group or a naphthyl group), an aromatic heterocyclic group (such as a furyl group, a pyrazolyl group, or a pyridyl group), an alkoxy group (such as methoxy, ethoxy, an i-propoxy group, or a hexyloxy group), an aryloxy group (such as a phenoxy group), an alkylthio group (such as a methylthio group or an ethylthio group), an arylthio group (such as a phenylthio group), an alkenyl group (such as a vinyl group or a 1-propenyl group), an alkoxysilyl group (such as a trimethoxysilyl group or a triethoxysilyl group), an acyloxy group (such as an acetoxy group or a (meth)acryloyl group), an alkoxycarbonyl group (such as a methoxycarbonyl group or an ethoxycarbonyl group), an aryloxycarbonyl group (such as a phenoxycarbonyl group), a carbamoyl group (such as a carbamoyl group, an N-methylcarbamoyl group, an N,N-dimethylcarbamoyl group, or an N-methyl-N-octylcarbamoyl group), an acylamino group (such as an acetylamino group, a benzoylamino group, an acrylamino group, or a methacrylamino group), or the like.

Out of these, more preferred is a hydroxyl group, a mercapto group, a carboxyl group, an epoxy group, an alkyl group, an alkoxysilyl group, an acyloxy group, or an acylamino group. Particularly preferred is an epoxy group, a polymerizable acyloxy group (such as (meth)acryloyl group), or a polymerizable acylamino group (such as an acrylamino group or a methacrylamino group). Whereas, these substituents may further be substituted.

R² denotes a substituted or unsubstituted alkyl group or acyl group. The explanations of an alkyl group, an acyl group, and a substituent are the same as with R¹. R² is preferably an unsubstituted alkyl group or an unsubstituted acyl group, and in particular preferably an unsubstituted alkyl group.

m denotes 0 or an integer of 1 to 3, and n denotes an integer of 1 to 4, provided that the sum of m and n is 4. When a plurality of R¹s or R²s are present, the plurality of R¹s or R²s may respectively be the same or different. m is preferably 0, 1, or 2, and in particular preferably 1.

Below, non-limiting specific examples of the compound represented by the formula A in the invention will be shown.

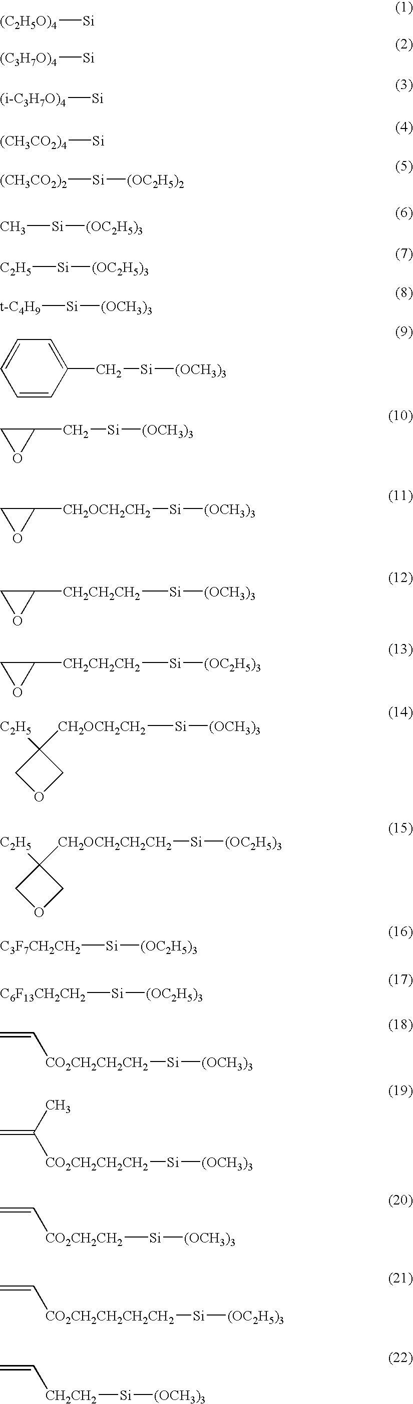

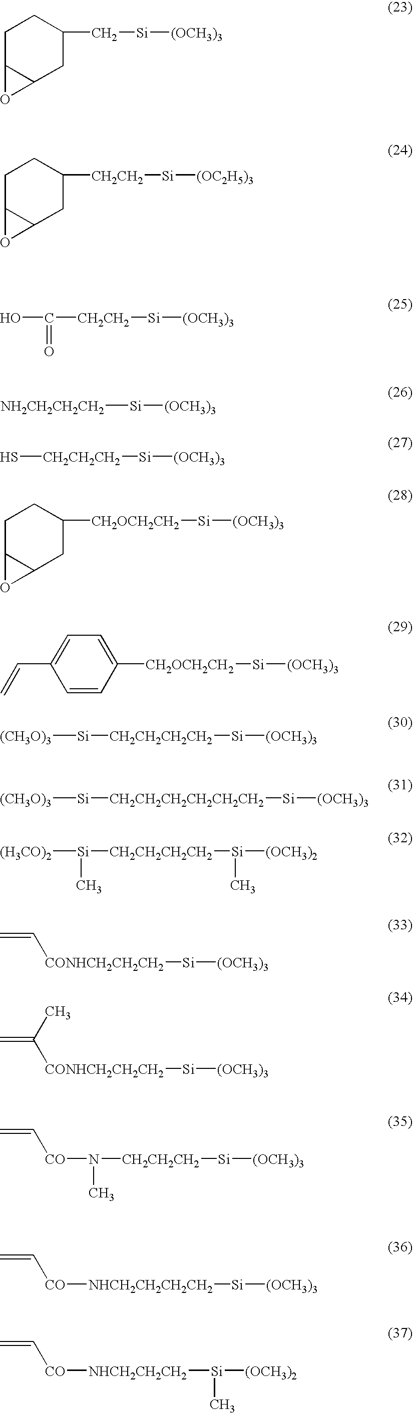

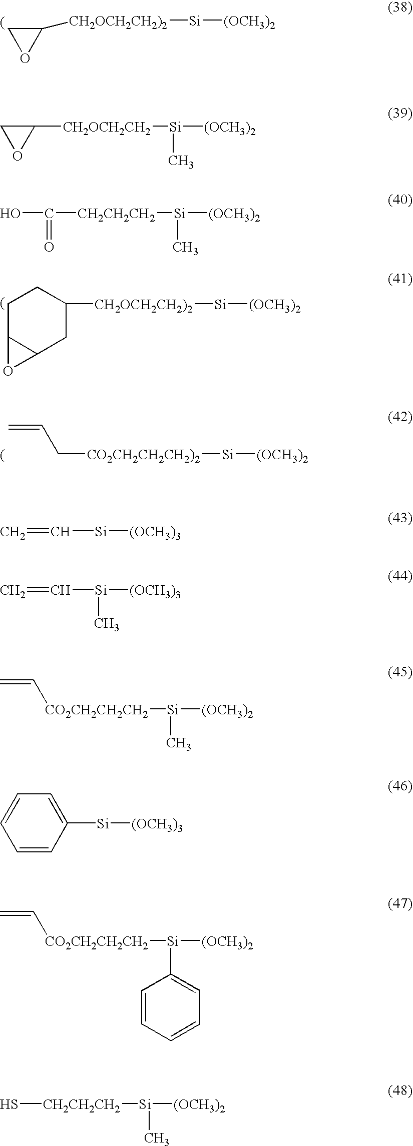

Out of these specific examples, (1), (12), (18), (19), and the like are particularly preferred.

The content of the compound of the formula A is preferably 1 to 90 mass %, more preferably 2 to 80 mass %, and in particular preferably 5 to 50 mass % based on the total solid content of the high refractive index layer.

Examples of the titanate coupling agent may include metal alkoxides such as tetramethoxytitanium, tetraethoxytitanium, and tetraisopropoxytitanium, and PLENACT (such as KR-TTS, KR-46B, KR-55, or KR-41B; manufactured by Ajinomoto Co., Inc.).

Examples of the organic compound for use in the surface treatment may include, preferably, polyol, alkanolamine, and organic compounds having other anionic groups, and in particular preferably, organic compounds having a carboxyl group, a sulfonic acid group, or a phosphoric acid group.

Stearic acid, lauric acid, oleic acid, linolic acid, linoleic acid, and the like may be preferably used.

The organic compounds for use in the surface treatment preferably further have crosslinkable or polymerizable functional groups. As the crosslinkable or polymerizable functional groups, mention may be made of ethylenic unsaturated groups capable of addition reaction/polymerization reaction by radical species (e.g., a (meth)acryl group, an allyl group, a styryl group, and a vinyloxy group), cationic polymerizable groups (such as an epoxy group, an oxatanyl group, and a vinyloxy group), and polycondensable groups (such as a hydrolyzable silyl group and an N-methylol group), and groups having ethylenic unsaturated groups are preferred.

These substances for the surface treatment may be used in combination of two or more thereof. It is particularly preferable to use an aluminum-containing inorganic compound and a zirconium-containing inorganic compound in combination.

The inorganic fine particles containing titanium dioxide as a main component of the invention may also have a core/shell structure as described in JP-A-2001-166104 by a surface treatment.

The inorganic fine particle containing titanium dioxide as a main component contained in the high refractive index layer preferably has a rice-grain shape, a spherical shape, a cubic shape, a spindle shape, or an indefinite shape, and in particular preferably has an indefinite shape or a spindle shape.

[Dispersant]

It is possible to use a dispersant for the dispersion of the inorganic fine particles containing titanium dioxide as a main component, for use in the high refractive index layer of the antireflection film of the invention.

It is particularly preferable to use a dispersant having an anionic group for the dispersion of the inorganic fine particles containing titanium dioxide as a main component of the invention.

The anionic groups are effectively groups having acidic protons such as a carboxyl group, a sulfonic acid group (and a sulfo group), a phosphoric acid group (and a phosphono group), and a sulfonamido group, or salts thereof, especially preferably a carboxyl group, a sulfonic acid group, and a phosphoric acid group, and salts thereof, and in particular preferably a carboxyl group and a phosphoric acid group. It is essential only that the dispersant contains one or more anionic groups per molecule.

A plurality of the anionic groups may also be contained for the purpose of more improving the dispersibility of the inorganic fine particles. An average of two or more anionic groups are preferably contained, more preferably five or more, and in particular preferably 10 or more. As for the anionic groups to be contained in the dispersant, a plurality of types of anionic groups may also be contained per molecule.

The dispersant preferably further contains a crosslinkable or polymerizable functional group. As the crosslinkable or polymerizable functional groups, mention may be made of ethylenic unsaturated groups capable of addition reaction/polymerization reaction by radical species (such as a (meth)acryloyl group, an allyl group, a styryl group, and a vinyloxy group), cationic polymerizable groups (such as an epoxy group, an oxatanyl group, and a vinyloxy group), and polycondensable groups (such as a hydrolyzable silyl group and an N-methylol group), and functional groups having ethylenic unsaturated groups are preferred.

Preferred dispersants to be used for the dispersion of the inorganic fine particles containing titanium dioxide as a main component for use in the high refractive index layer of the invention are dispersants having anionic groups and crosslinkable or polymerizable functional groups, and having the crosslinkable or polymerizable groups at side chains.

The weight-average molecular weight (Mw) of the dispersant having anionic groups, and crosslinkable or polymerizable functional groups, and having the crosslinkable or polymerizable groups at side chains has no particular restriction. It is preferably 1000 or more. The weight-average molecular weight (Mw) of the dispersant is more preferably 2000 to 100000, more preferably 5000 to 200000, and in particular preferably 10000 to 100000.

The anionic groups are effectively groups having acidic protons such as a carboxyl group, a sulfonic acid group (and a sulfo group), a phosphoric acid group (and a phosphono group), and a sulfonamido group, or salts thereof, especially preferably a carboxyl group, a sulfonic acid group, and a phosphoric acid group, and salts thereof, and in particular preferably a carboxyl group and a phosphoric acid group. The number of anionic groups per molecule contained in the dispersant is, on an average, preferably 2 or more, more preferably 5 or more, and in particular preferably 10 or more. As for the anionic groups to be contained in the dispersant, a plurality of types of anionic groups may also be contained per molecule.

The dispersants having anionic groups and crosslinkable or polymerizable functional groups, and having the crosslinkable or polymerizable groups in the side chains have the anionic groups in the side chains or at the terminals. The anionic groups may be introduced into the side chains for synthesis utilizing the polymer reaction of a method of polymerizing, for example, anionic group-containing monomers (e.g., (meth)acrylic acid, maleic acid, partially esterified maleic acid, itaconic acid, crotonic acid, 2-carboxyethyl(meth)acrylate, 2-sulfoethyl (meth)acrylate, and phosphoric acid mono-2-(meth)acryloyloxyethyl ester), a method of allowing an acid anhydride to act on a polymer having a hydroxyl group, an amino group, or the like, or other methods.

In the dispersant having anionic groups in the side chains, the composition ratio of anionic group-containing repeating units is in the range of 10⁻⁴ to 100 mol %, preferably 1 to 50 mol %, and in particular preferably 5 to 20 mol % based on the amount of the total repeating units.

On the other hand, the anionic groups may be introduced into the terminals for synthesis with a method of effecting a polymerization reaction in the presence of an anionic group-containing chain transfer agent (such as thioglycolic acid), a method of effecting a polymerization reaction using an anionic group-containing polymerization initiator (such as V-501 manufactured by Wako Pure Chemical Industries, Ltd.), or other methods.

Particularly preferred dispersants are dispersants having anionic groups in the side chains.

As the crosslinkable or polymerizable functional groups, mention may be made of ethylenic unsaturated groups capable of addition reaction/polymerization reaction by radical species (such as a (meth)acryl group, an allyl group, a styryl group, and a vinyloxy group), cationic polymerizable groups (such as an epoxy group, an oxatanyl group, and a vinyloxy group), and polycondensable groups (such as a hydrolyzable silyl group and an N-methylol group), and groups having ethylenic unsaturated groups are preferred.

The number of the crosslinkable or polymerizable functional groups contained per molecule in the dispersant is, on an average, preferably 2 or more, more preferably 5 or more, and in particular preferably 10 or more per molecule. As for the crosslinkable or polymerizable functional groups to be contained in the dispersant, a plurality of types thereof may also be contained per molecule.

In the preferred dispersant for use in the invention, examples of the repeating unit having an ethylenic unsaturated group at the side chain include repeating units of poly-1,2-butadiene and poly-1,2-isoprene structures or (meth)acrylic acid ester or amide. The ones in each of which a specific residue (R group of —COOR or —CONHR) is bonded thereto are usable. Examples of the specific residue (R group) may include: —(CH₂)ₙ—CR₁═CR₂R₃, —(CH₂O)ₙ—CH₂CR₁═CR₂R₃, —(CH₂CH₂O)ₙ—CH₂CR₁═CR₂R₃, —(CH₂)ₙ—NH—CO—O—CH₂CR₁═CR₂R₃, —(CH₂)ₙ—O—CO—CR₁═CR₂R₃, and —(CH₂CH₂O)₂—X (where R₁ to R₃ are each a hydrogen atom, a halogen atom, or an alkyl group, an aryl group, an alkoxy group, or an aryloxy group, having 1 to 20 carbon atoms, and R₁ and R₂ or R₃ may also combine with each other to form a ring; n is an integer of 1 to 10; and X is a dicyclopentadiene residue.). Specific examples of the ester residue may include: —CH₂CH═CH₂ (corresponding to allyl(meth)acrylate polymer described in JP-A-64-17047), —CH₂CH₂O—CH₂CH═CH₂, —CH₂CH₂OCOCH═CH₂, —CH₂CH₂OCOC(CH₃)═CH₂, —CH₂C(CH₃)═CH₂, —CH₂CH═CH—C₆H₅, —CH₂CH₂OCOCH═CH—C₆H₅, —CH₂CH₂—NHCOO—CH₂CH═CH₂, and CH₂CH₂O—X (where X is a dicyclopentadienyl residue). Specific examples of the amide residue may include: —CH₂CH═CH₂, —CH₂CH₂—Y (where Y is a 1-cyclohexenyl residue), and —CH₂CH₂—OCO—CH═CH₂, and —CH₂CH₂—OCO—C(CH₃)═CH₂.

In the dispersant having the ethylenic unsaturated group, to the unsaturated bond group, a free radical (a polymerization initiator radial or a growing radical in the process of polymerization of a polymerizable compound) is added, and addition polymerization occurs directly or through chain polymerization of the polymerizable compound between the molecules. This results in the formation of crosslinking, which causes curing. Alternatively, the atoms in the molecules (such as hydrogen atoms on the carbon atoms adjacent to the unsaturated bond groups) are attracted by free radicals to generate polymer radicals. These combine with each other to form crosslinking between the molecules, which causes curing.

The crosslinkable or polymerizable functional groups may be introduced in the side chains, as described in, for example, JP-A-3-249653, by carrying out copolymerization of crosslinkable or polymerizable functional group-containing monomers (such as allyl(meth)acrylate, glycidyl(meth)acrylate, and trialkoxysilylpropyl methacrylate), copolymerization of butadiene or isoprene, or copolymerization of vinyl monomers having 3-chloropropionic acid ester moieties, and then carrying out dehydrochlorination. Alternatively, the crosslinkable or polymerizable functional groups may be introduced for synthesis by a polymer reaction (such as a polymer reaction of epoxy group-containing vinyl monomers with carboxyl group-containing polymers), or other methods.

The crosslinkable or polymerizable functional group-containing units may constitute all the repeating units other than the anionic group-containing repeating units. However, these account for 5 to 50 mol %, and in particular preferably 5 to 30 mol % of the total amount of the crosslinkable or polymerizable repeating units.

The preferred dispersants of the invention may be copolymers with appropriate monomers other than the monomers having the crosslinkable or polymerizable functional groups and the anionic groups. The copolymerizable components have no particular restriction. However, these are selected from various viewpoints such as the dispersion stability, the compatibility with other monomer components, and the strength of the formed film. Preferred examples thereof may include methyl (meth)acrylate, n-butyl(meth)acrylate, t-butyl (meth)acrylate, cyclohexyl(meth)acrylate, and styrene.

The forms of the preferred dispersants of the invention have no particular restriction. However, the dispersants are preferably block copolymers or random copolymers, and in particular preferably random copolymers in terms of the cost and the ease of synthesis.

Below, non-limiting specific examples of the dispersants to be preferably used in the invention will be shown. Incidentally, random copolymers are shown unless otherwise stated.

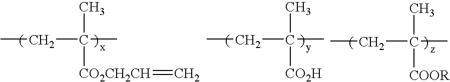

| | x | y | z | R | Mw |
|---|---|---|---|---|---|
| P-(1) | 80 | 20 | 0 | — | 40,000 |
| P-(2) | 80 | 20 | 0 | — | 110,000 |
| P-(3) | 80 | 20 | 0 | — | 10.000 |
| P-(4) | 90 | 10 | 0 | — | 40,000 |
| P-(5) | 50 | 50 | 0 | — | 40,000 |
| P-(6) | 30 | 20 | 50 | CH₂CH₂CH₃ | 30,000 |
| P-(7) | 20 | 30 | 50 | CH₂CH₂CH₂CH₃ | 50,000 |
| P-(8) | 70 | 20 | 10 | CH(CH₃)₃ | 60,000 |
| P-(9) | 70 | 20 | 10 | 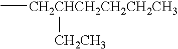 | 150,000 |
| P-(10) | 40 | 30 | 30 | 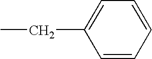 | 15,000 |

x/y/z represents the molar ratio.

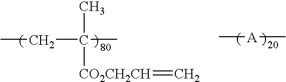

| | A | Mw |
|---|---|---|
| P-(11) | 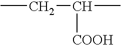 | 20,000 |
| P-(12) | 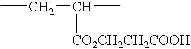 | 30,000 |
| P-(13) | 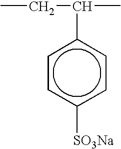 | 100,000 |
| P-(14) | 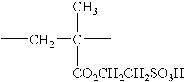 | 20,000 |
| P-(15) | 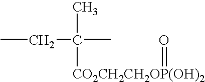 | 50,000 |
| P-(16) | 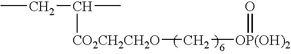 | 15,000 |

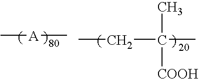

| | A | Mw |
|---|---|---|
| P-(17) | 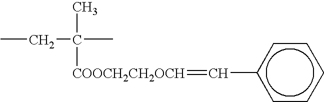 | 20,000 |
| P-(18) | 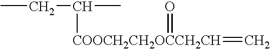 | 25,000 |
| P-(19) | 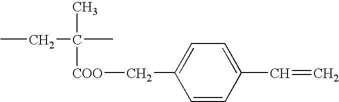 | 18,000 |
| P-(20) | 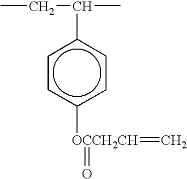 | 20,000 |
| P-(21) | 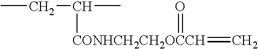 | 35,000 |

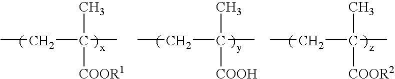

| | R¹ | R² | x | y | z | Mw |
|---|---|---|---|---|---|---|
| P-(22) | 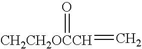 | C₄H₉(n) | 10 | 10 | 80 | 25,000 |
| P-(23) | 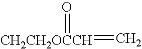 | C₄H₉(t) | 10 | 10 | 80 | 25,000 |
| P-(24) | 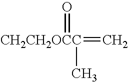 | C₄H₉(n) | 10 | 10 | 80 | 500,000 |
| P-(25) | 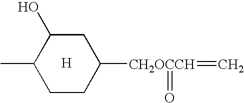 | C₄H₉(n) | 10 | 10 | 80 | 23,000 |
| P-(26) | 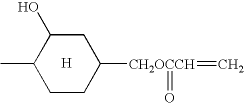 | C₄H₉(n) | 10 | 10 | 10 | 30,000 |
| P-(27) | 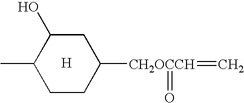 | C₄H₉(n) | 50 | 20 | 30 | 30,000 |
| P-(28) | 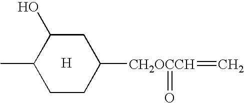 | C₄H₉(t) | 10 | 10 | 80 | 20,000 |
| P-(29) | 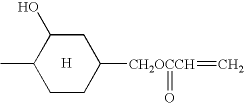 | CH₂CH₂OH | 50 | 10 | 40 | 20,000 |
| P-(30) | 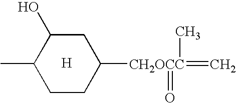 | C₄H₉(n) | 10 | 10 | 80 | 25,000 |

| | | |
|---|---|---|
| P-(31) | 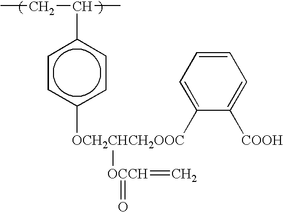 | Mw = 60,000 |
| P-(32) | 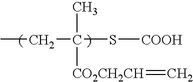 | Mw = 10,000 |
| P-(33) | 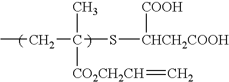 | Mw = 20,000 |
| P-(34) | 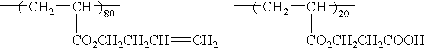 | Mw = 30,000 (Block copolymer) |
| P-(35) | 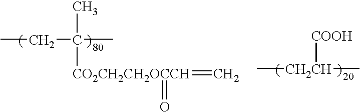 | Mw = 15,000 (Block copolymer) |

(Block copolymer) (Block copolymer)

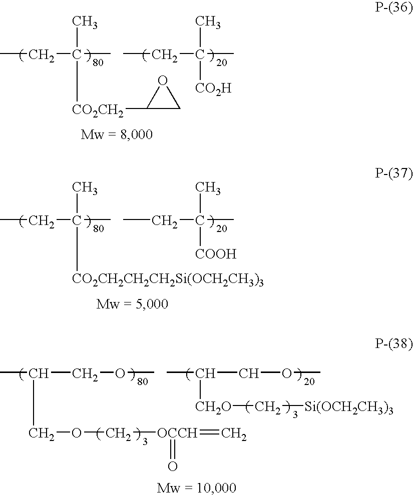

The amount of the dispersant to be used based on the amount of the inorganic fine particles is preferably in the range of 1 to 50 mass %, more preferably in the range of 5 to 30 mass %, and most preferably in the range of 5 to 20 mass %. Further, the dispersants may be used in combination of two or more thereof.

[High Refractive Index Layer and Formation Method Thereof]

The inorganic fine particles for use in the high refractive index layer are used in the form of a dispersion for the formation of the high refractive index layer.

For dispersion of the inorganic fine particles, the dispersion is carried out in the presence of the foregoing dispersant in a dispersion medium.

As the dispersion medium, a liquid having a boiling point of 60 to 170° C. is preferably used. Examples of the dispersion medium include: water, alcohols (e.g., methanol, ethanol, isopropanol, butanol, and benzyl alcohol), ketones (e.g., acetone, methyl ethyl ketone, methyl isobutyl ketone, and cyclohexanone), esters (e.g., methyl acetate, ethyl acetate, propyl acetate, butyl acetate, methyl formate, ethyl formate, propyl formate, and butyl formate), aliphatic hydrocarbons (e.g., hexane and cyclohexane), hydrocarbon halides (e.g., methylene chloride, chloroform, and carbon tetrachloride), aromatic hydrocarbons (e.g., benzene, toluene, and xylene), amides (e.g., dimethylformamide, dimethylacetamide, and n-methylpyrrolidone), ethers (e.g., diethyl ether, dioxane, and tetrahydrofuran), and ether alcohols (e.g., 1-methoxy-2-propanol). Toluene, xylene, methyl ethyl ketone, methyl isobutyl ketone, cyclohexanone, and butanol are preferred.

Particularly preferred dispersion media are methyl ethyl ketone, methyl isobutyl ketone, and cyclohexanone.

The inorganic fine particles are dispersed by means of a dispersing machine. Examples of the dispersing machine may include a sand grinder mill (e.g., a beads-mill equipped with pins), a high speed impeller mill, a pebble mill, a roller mill, an attritor, and a colloid mill. A sand grinder mill and a high speed impeller mill are particularly preferred. Whereas, a pre-dispersing treatment may also be performed. Examples of the dispersing machine to be used for the pre-dispersing treatment may include a ball mill, a three-roller mill, a kneader, and an extruder.

The inorganic fine particles have been preferably reduced in size as small as possible in a dispersion medium, and have a mass average diameter of 1 to 200 nm, preferably 5 to 150 nm, more preferably 10 to 100 nm, and in particular preferably 10 to 80 nm.

By reducing the size of the inorganic fine particles to 200 nm or less, it is possible to form a high refractive index layer not impairing the transparency.

The high refractive index layer for use in the invention is preferably formed in the following manner. In the dispersion prepared by dispersing the inorganic fine particles in the dispersion medium in the foregoing manner, preferably, a binder precursor (such as an ionizing radiation-curable multifunctional monomer or multifunctional oligomer) necessary for the matrix formation, a photopolymerization initiator, and the like are further added to prepare a coating solution for forming the high refractive index layer. The resulting coating solution for forming the high refractive index layer is coated on a transparent support, and cured by the crosslinking reaction or the polymerization reaction of an ionizing radiation-curable compound (such as a multifunctional monomer or a multifunctional oligomer).

Further, the binder in the high refractive index layer is preferably allowed to undergo a crosslinking reaction or a polymerization reaction with the dispersant simultaneously with coating or after coating of the layer.

As for the binder in the high refractive index layer produced in this manner, for example, the preferred dispersant and the ionizing radiation-curable multifunctional monomer or multifunctional oligomer undergo a crosslinking or polymerization reaction. This results in the form in which the anionic group of the dispersant is incorporated in the binder. Further, in the binder in the high refractive index layer, the anionic group has a function of keeping the dispersion state of the inorganic fine particles, and the crosslinked or polymerized structure imparts a film forming ability to the binder, resulting in improvements of the physical strengths, the chemical resistances, and the weather resistances of the high refractive index layer containing the inorganic fine particles.

The functional group of the ionizing radiation-curable multifunctional monomer or multifunctional oligomer is preferably the light-, electron beam-, or radiation-polymerizable one. Especially, a photopolymerizable functional group is preferred.

As the photopolymerizable functional groups, mention may be made of unsaturated polymerizable functional groups such as a (meth)acryloyl group, a vinyl group, a styryl group, and an allyl group, and the like. Out of these, a (meth)acryloyl group is preferred.

Specific examples of the photopolymerizable multifunctional monomer having a photopolymerizable functional group may include:

(meth)acrylic acid diesters of alkylene glycol such as neopentyl glycol acrylate, 1,6-hexanediol (meth)acrylate, and propylene glycol di(meth)acrylate;

(meth)acrylic acid diesters of polyoxyalkylene glycol such as triethylene glycol di(meth)acrylate, dipropylene glycol di(meth)acrylate, polyethylene glycol di(meth)acrylate, and polypropylene glycol di(meth)acrylate;

(meth)acrylic acid diesters of polyhydric alcohol such as pentaerythritol di(meth)acrylate; and

(meth)acrylic acid diesters of an ethylene oxide or propylene oxide adduct such as 2,2-bis{4-(acryloxy.diethoxy) phenyl}propane and 2-2-bis{4-(acryloxy.polypropoxy)phenyl}propane.

Further, epoxy(meth)acrylates, urethane (meth)acrylates, and polyester (meth)acrylates are also preferably used as the photopolymerizable multifunctional monomers.

Out of these, esters of polyhydric alcohol and (meth)acrylic acid are preferred. Multifunctional monomers having 3 or more (meth)acryloyl groups per molecule are more preferred. Specific examples thereof may include: trimethylolpropane tri(meth)acrylate, trimethylolethane tri(meth)acrylate, 1,2,4-cyclohexane tetra(meth)acrylate, pentaglycerol triacrylate, pentaerythritol tetra(meth)acrylate, pentaerythritol tri(meth)acrylate, (di)pentaerythritol, triacrylate, (di)pentaerythritol pentacrylate, (di)pentaerythritol tetra(meth)acrylate, (di)pentaerythritol hexa(meth)acrylate, tripentaerythritol triacrylate, and tripentaerythritol hexatriacrylate.

The multifunctional monomers may also be used in combination of two or more types thereof.

A photopolymerization initiator is preferably used for the polymerization reaction of the photopolymerizable multifunctional monomers. The photopolymerization initiator is preferably a radical photopolymerization initiator or a cationic photopolymerization initiator. A radical photopolymerization initiator is particularly preferred.

Examples of the radical photopolymerization initiator may include: acetophenones, benzophenones, Michler's benzoyl benzoate, α-amyloxime esters, tetramethylthiuram monosulfide, and thioxanthones.

As the commercially available radical photopolymerization initiator, mention may be made of KAYACURE (DETX-S, BP-100, BDMK, CTX, BMS, 2-EAQ, ABQ, CPTX, EPD, ITX, QTX, BTC, MCA, or the like) manufactured by NIPPON KAYAKU Co., Ltd., Irgacure (651, 184, 500, 907, 369, 1173, 2959, 4265, 4263, or the like) manufactured by Ciba-Geigy Japan, Ltd., Esacure (KIP100F, KB1, EB3, BP, X33, KT046, KT37, KIP150, TZT, or the like) manufactured by Sartomer Co., or the like.

Particularly, a photocleavable type radical photopolymerization initiator is preferred. The photocleavable type radical photopolymerization initiator is described in SAISHIN UV KOKA GIJUTSU (Latest W Curing Technique) (p. 159, publisher; Kazuhiro Takausu, publisher; GIJUTSU JOHO KYOKAI, Co., Ltd., issued in 1991).

As commercially available photocleavable type radical photopolymerization initiators, mention may be made of Irgacure (651, 184, or 907) manufactured by Ciba-Geigy Japan, Ltd., and the like.

The photopolymerization initiator is used in an amount preferably in the range of 0.1 to 15 parts by mass, and more preferably in the range of 1 to 10 parts by mass per 100 parts by mass of a multifunctional monomer.

In addition to the photopolymerization initiator, a photosensitizer may also be used. Specific examples of the photosensitizer may include n-butylamine, triethylamine, tri-n-butylphosphine, Michler's ketone, and thioxanthone.

As the commercially available photosensitizers, mention may be made of KAYACURE (DMBI or EPA) manufactured by NIPPON KAYAKU Co., Ltd., and the like.

The photopolymerization reaction is preferably effected through ultraviolet irradiation after coating and drying of the high refractive index layer.

The high refractive index layer for use in the invention can also contain the compound represented by the formula A and/or a derivative compound thereof.

The binder in the high refractive index layer preferably further has a silanol group. Further inclusion of a silanol group in the binder more improves the physical strengths, chemical resistance, and weather resistances of the high refractive index layer.

A silanol group can be introduced into the binder in the following manner. For example, the compound represented by the formula A, having a crosslinkable or polymerizable functional group is added to the coating composition for forming the high refractive index layer. The resulting coating composition is coated on a transparent support, so that the dispersant, the multifunctional monomer or the multifunctional oligomer, and the compound represented by the formula A are allowed to undergo a crosslinking reaction or a polymerization reaction.

The compounds represented by the formula A, to be introduced into the binder are in particular preferably compounds having a (meth)acryloyl group as a crosslinkable or polymerizable functional group. Examples thereof may include 3-acryloxypropyltrimethoxysilane and 3-methacryloxypropyltrimethoxysilane.

The binder in the high refractive index layer also preferably has an amino group or a quaternary ammonium group.

The binder in the high refractive index layer, having an amino group or a quaternary ammonium group can be formed in the following manner. For example, a monomer having a crosslinkable or polymerizable functional group, and an amino group or a quaternary ammonium group is added to the coating composition for forming the high refractive index layer. The resulting coating composition is coated on a transparent support, so that a crosslinking reaction or a polymerization reaction with the dispersant, and the multifunctional monomer or the multifunctional oligomer is effected.

The monomer having an amino group or a quaternary ammonium group functions as a dispersion aid for the inorganic fine particles in the coating composition. Further, after coating, it is allowed to undergo a crosslinking reaction or a polymerization reaction with the dispersant, and the multifunctional monomer or the multifunctional oligomer, resulting in a binder. This allows the favorable dispersibility of the inorganic fine particles in the high refractive index layer to be kept, and enables the manufacturing of a high refractive index layer excellent in physical strengths, chemical resistance, and weather resistances.

As preferred monomers having an amino group or a quaternary ammonium group, mention may be made of N,N-dimethylaminoethyl (meth)acrylate, N,N-dimethylaminopropyl (meth)acrylate, hydroxypropyl trimethylammonium chloride (meth)acrylate, dimethylallylammonium chloride, and the like.

The amount of the monomers having an amino group or a quaternary ammonium group to be used based on the amount of the dispersant is preferably in the range of 1 to 40 mass %, more preferably in the range of 3 to 30 mass %, and in particular preferably in the range of 3 to 20 mass %. A binder is formed by a crosslinking or polymerization reaction simultaneously with coating, or after coating of the high refractive index layer. This allows the monomers to effectively function before coating of the high refractive index layer.

The crosslinked or polymerized binder has a structure in which the main chain of the polymer is crosslinked or polymerized. Examples of the main chain of the polymer may include polyolefin (saturated hydrocarbon), polyether, polyurea, polyurethane, polyester, polyamine, polyamide, and melamine resins. A polyolefin main chain, a polyether main chain, and a polyurea main chain are preferred. A polyolefin main chain and a polyether main chain are further preferred, and a polyolefin main chain is most preferred.

The polyolefin main chain comprises saturated hydrocarbons. The polyolefin main chain can be obtained, for example, by the addition polymerization reaction of unsaturated polymerizable groups. The polyether main chain comprises repeating units linked to each other through ether linkages (—O—). The polyether main chain can be obtained, for example, by the ring-opening polymerization reaction of epoxy groups. The polyurea main chain comprises repeating units linked to each other through urea linkages (—NH—CO—NH—). The polyurea main chain can be obtained, for example, by the condensation polymerization reaction between an isocyanate group and an amino group. The polyurethane main chain comprises repeating units linked to each other through urethane linkages (—NH—CO—O—). The polyurethane main chain can be obtained, for example, by the condensation polymerization reaction between an isocyanate group and a hydroxyl group (including an N-methylol group). The polyester main chain comprises repeating units linked to each other through ester linkages (—CO—O—). The polyester main chain can be obtained, for example, by the condensation polymerization reaction between a carboxyl group (including an acid halide group) and a hydroxyl group (including an N-methylol group). The polyamine main chain comprises repeating units linked to each other through imino linkages (—NH—). The polyamine main chain can be obtained, for example, by the ring-opening polymerization reaction of an ethylenimine group. The polyamide main chain comprises repeating units linked to each other through amido linkages (—NH—CO—). The polyamide main chain can be obtained, for example, by the reaction between an isocyanate group and a carboxyl group (including an acid halide group). The melamine resin main chain can be obtained, for example, by the condensation polymerization reaction between a triazine group (e.g., melamine) and aldehyde (e.g., formaldehyde). Incidentally, in the melamine resin, the main chain itself has a crosslinked or polymerized structure.

The anionic group is preferably linked as a side chain of the binder to the main chain via a linking group.

The linking group for linking the anionic group to the main chain of the binder is preferably —CO—, —O—, an alkylene group, an arylene group, and a divalent group selected from a combination of these. The crosslinked or polymerized structure chemically links (preferably, covalently links) two or more main chains. The crosslinked or polymerized structure preferably covalently links three or more main chains. The crosslinked or polymerized structure preferably comprises —CO—, —O—, —S—, nitrogen atom, phosphorus atom, aliphatic residues, aromatic residues, and a divalent group selected from combination of these.

The binder is preferably a copolymer having a repeating unit having an anionic group and another repeating unit having a crosslinked or polymerized structure. The proportion of the repeating units having an anionic group in the copolymer is preferably 2 to 96 mol %, further preferably 4 to 94 mol %, and most preferably 6 to 92 mol %. The repeating unit may have two or more anionic groups. The proportion of the repeating units having a crosslinked or polymerized structure in the copolymer is preferably 4 to 98 mol %, further preferably 6 to 96 mol %, and most preferably 8 to 94 mol %.

The repeating unit of the binder may also have both of an anionic group and a crosslinked or polymerized structure. The binder may also contain other repeating units (repeating units having neither anionic group nor crosslinked or polymerized structure).

The other repeating unit is preferably a repeating unit having a silanol group, an amino group, or a quaternary ammonium group.

In the repeating unit having a silanol group, the silanol group is directly linked to the main chain of the binder, or linked to the main chain through a linking group. The silanol group is preferably linked to the main chain through a linking group as a side chain. The linking group for linking the silanol group to the main chain of the binder is preferably —CO—, —O—, an alkylene group, or an arylene group, or a divalent group selected from a combination thereof. When the binder contains a repeating unit having a silanol group, the proportion thereof is preferably 2 to 98 mol %, further preferably 4 to 96 mol %, and most preferably 6 to 94 mol %.

In the repeating unit having an amino group or a quaternary ammonium group, the amino group or the quaternary ammonium group is directly linked to the main chain of the binder, or linked to the main chain through a linking group. The amino group or the quaternary ammonium group is preferably linked as a side chain to the main chain through a linking group. The amino group or the quaternary ammonium group is preferably a secondary amino group, a tertiary amino group, or a quaternary ammonium group, and further preferably a tertiary amino group or a quaternary ammonium group. The group to be linked to the nitrogen atom of a secondary amino group, a tertiary amino group, or a quaternary ammonium group is preferably an alkyl group, more preferably an alkyl group having 1 to 12 carbon atoms, and further preferably an alkyl group having 1 to 6 carbon atoms. The counter ion of the quaternary ammonium group is preferably a halide ion. The linking groups for linking the amino group or the quaternary ammonium group to the main chain of the binder are preferably —CO—, —NH—, —O—, an alkylene group, an arylene group, and a divalent group selected from a combination thereof. When the binder contains the repeating units having an amino group or a quaternary ammonium group, the proportion thereof is preferably 0.1 to 32 mol %, further preferably 0.5 to 30 mol %, and most preferably 1 to 28 mol %.

Incidentally, even when a silanol group, and an amino group or a quaternary group are contained in the repeating unit having an anionic group or the repeating unit having a crosslinked or polymerized structure, it is possible to obtain the same effects.

The crosslinked or polymerized binder is preferably formed in the following manner. A coating composition for forming the high refractive index layer is coated on a transparent support. Simultaneously with coating or after coating, a crosslinking or polymerization reaction is effected.

The inorganic fine particles have an effect of controlling the refractive index of the high refractive index layer, and a function of inhibiting the curing and shrinkage.

In the high refractive index layer, the inorganic fine particles are preferably dispersed as finely as possible, and have a mass average diameter of 1 to 200 nm. The inorganic fine particles in the high refractive index layer have a mass average diameter of preferably 5 to 150 nm, more preferably 10 to 100 nm, and in particular preferably 10 to 80 nm.

By reducing the size of the inorganic fine particles to 200 nm or less, it is possible to form a high refractive index layer not impairing the transparency.

The content of the inorganic fine particles in the high refractive index layer is preferably 10 to 90 mass %, more preferably 15 to 80 mass %, and in particular preferably 15 to 75 mass % based on the mass of the high refractive index layer. The inorganic fine particles may be used in combination of two or more types thereof in the high refractive index layer.

When the antireflection film has a low refractive index layer on the high refractive index layer, the refractive index of the high refractive index layer is preferably higher than the refractive index of the transparent support.

For the high refractive index layer, it is also possible to preferably use a binder obtainable by the crosslinking or polymerization reaction of an ionizing radiation-curable compound containing an aromatic ring, an ionizing radiation-curable compound containing a halogen element other than fluorine (e.g., Br, I, or Cl), an ionizing radiation-curable compound containing an atom such as S, N, or P, or the like.

In order to form a low refractive index layer on the high refractive index layer, and thereby manufacturing an antireflection film, the refractive index of the high refractive index layer is preferably 1.55 to 2.40, more preferably 1.60 to 2.20, further preferably 1.65 to 2.10, and most preferably 1.80 to 2.00.

To the high refractive index layer, it is also possible to add, other than the foregoing components (such as inorganic fine particles, a polymerization initiator, and a photosensitizer), a resin, a surfactant, an antistatic agent, a coupling agent, a thickener, an anti-coloring agent, a coloring agent (pigment or dye), an antifoaming agent, a levelling agent, a flame retardant, an ultraviolet absorber, an infrared absorber, a tackifier, a polymerization inhibitor, an antioxidant, a surface modifier, conductive metal fine particles, and the like.

Whereas, the high refractive index layer can also be allowed to contain particles with an average particle diameter of 0.2 to 10 μm described later, and thereby it can also serve as an antiglare layer which has acquired an antiglare function.

It is possible to design the high refractive index layer with an appropriate thickness according to the intended purpose. When the high refractive index layer is used as an optical interference layer described later, the thickness is preferably 30 to 200 nm, more preferably 50 to 170 nm, and in particular preferably 60 to 150 nm. When the high refractive index layer also serves as a hard coat layer, the thickness is preferably 0.5 to 10 μm, more preferably 1 to 7 μm, and in particular preferably 2 to 5 μm.

For the formation of the high refractive index layer, the crosslinking reaction or the polymerization reaction of an ionizing radiation-curable compound is preferably carried out in an atmosphere with an oxygen concentration of 10% by volume or less.

By forming the high refractive index layer in an atmosphere with an oxygen concentration of 10% by volume or less, it is possible to improve the physical strengths, chemical resistance, and weather resistances of the high refractive index layer, and further, the adhesion between the high refractive index layer and a layer adjacent to the high refractive index layer.

The high refractive index layer is formed by the crosslinking reaction or the polymerization reaction of an ionizing radiation-curable compound in an atmosphere preferably with an oxygen concentration of 6% by volume or less, further preferably with an oxygen concentration of 4% by volume or less, in particular preferably with an oxygen concentration of 2% by volume or less, and most preferably 1% by volume or less.

The oxygen concentration is set at 10% by volume or less in the following manner. The air (nitrogen concentration: about 79% by volume, oxygen concentration: about 21% by volume) is preferably replaced with another gas, and in particular preferably replaced with nitrogen (purged with nitrogen).

The preferred coating solvents for the high refractive index layer are methyl ethyl ketone, methyl isobutyl ketone, and cyclohexanone.

The coating solvents may contain solvents other than ketone type solvents. Examples thereof may include: alcohols (e.g., methanol, ethanol, isopropanol, butanol, and benzyl alcohol), esters (e.g., methyl acetate, ethyl acetate, propyl acetate, butyl acetate, methyl formate, ethyl formate, propyl formate, and butyl formate), aliphatic hydrocarbons (e.g., hexane and cyclohexane), hydrocarbon halides (e.g., methylene chloride, chloroform, and carbon tetrachloride), aromatic hydrocarbons (e.g., benzene, toluene, and xylene), amides (e.g., dimethylformamide, dimethylacetamide, and n-methylpyrrolidone), ethers (e.g., diethyl ether, dioxane, and tetrahydrofuran), and ether alcohols (e.g., 1-methoxy-2-propanol).

In the coating solvent, the content of the ketone type solvent is preferably 10 mass % or more based on the total amount of solvents contained in the coating composition. It is preferably 30 mass % or more, and further preferably 60 mass % or more.

The strength of the high refractive index layer is preferably H or more, further preferably 2H or more, and most preferably 3H or more in the pencil hardness test according to JIS K5400.

Whereas, with the Taber test according to JIS K5400, a smaller amount of abrasion loss of a test piece before and after the test is preferred.

The high refractive index layer preferably has a lower haze when it does not contain particles for imparting an antiglare function. The haze is preferably 5% or less, further preferably 3% or less, and in particular preferably 1% or less.

The high refractive index layer is preferably formed directly or via another layer on the transparent support.

[Low Refractive Index Layer]

The low refractive index layer of the antireflection film of the invention is formed of a cured film of a copolymer comprising repeating units derived from fluorine-containing vinyl monomers, and repeating units each having a (meth)acryloyl group on the side chain as essential constituent components. The component derived from the copolymer preferably accounts for 70 mass % or more, more preferably 80 mass % or more, and in particular preferably 90 mass % or more of the solid content of the film. The mode in which a curing agent such as multifunctional (meth)acrylate is added is not preferred from the viewpoints of simultaneous implementation of lower refractive index and higher film hardness, and the compatibility.

The refractive index of the low refractive index layer is preferably 1.20 to 1.49, more preferably 1.20 to 1.45, and in particular preferably 1.20 to 1.44.

The thickness of the low refractive index layer is preferably 50 to 400 nm, and further preferably 50 to 200 nm. The haze of the low refractive index layer is preferably 3% or less, further preferably 2% or less, and most preferably 1% or less. The specific strength of the low refractive index layer is preferably H or more, further preferably 2H or more, and most preferably 3H or more in a 1-kg load pencil hardness test.

Whereas, in order to improve the stain proof property of the antireflection film, the contact angle to water of the surface is preferably 90° or more, further preferably 95° or more, and in particular preferably 100° or more.

Below, a description will be given to the copolymer for use in the low refractive index layer of the invention.

As the fluorine-containing vinyl monomers, mention may be made of fluoroolefins (e.g. fluoroethylene, vinylidene fluoride, tetrafluoroethylene, hexafluoroethylene, and hexafluoropropylene), partially or fully fluorinated alkyl ester derivatives of (meth)acrylic acid (e.g., BISCOAT 6FM (trade name, manufactured by Osaka Organic Chemical Industry, Ltd.), and M-2020 (trade name, manufactured by Daikin Industries, Ltd.), and fully or partially fluorinated vinyl ethers. Perfluoroolefins are preferred. Hexafluoropropylene is particularly preferred from the viewpoints of the refractive index, the solubility, the transparency, the availability, and the like. An increase in the composition ratio of these fluorine-containing vinyl monomers can reduce the refractive index, but reduces the coating film strength. In the invention, the fluorine-containing vinyl monomers are introduced so that the fluorine content of the copolymer is preferably 20 to 60 mass %, more preferably 25 to 55 mass %, and in particular preferably 30 to 50 mass %.

The copolymer of the invention has a repeating unit having a (meth)acryloyl group on the side chain as an essential constituent component. The process for introducing a (meth)acryloyl group into the copolymer has no particular restriction. Examples thereof may include:

(1) a process in which a polymer having a nucleophilic group such as a hydroxyl group or an amino group is synthesized, and then, (meth)acrylic acid chloride, (meth)acrylic anhydride, mixed acid anhydride of (meth)acrylic acid and methanesulfonic acid, or the like is allowed to act thereon; (2) a process in which (meth)acrylic acid is allowed to act on the polymer having a nucleophilic group in the presence of a catalyst such as sulfuric acid; (3) a process in which a compound having both an isocyanate group such as methacryloyloxy propyl isocyanate and a (meth)acryloyl group is allowed to act on the polymer having a nucleophilic group; (4) a process in which a polymer having an epoxy group is synthesized, and then, (meth)acrylic acid is allowed to act thereon; (5) a process in which a compound having both an epoxy group such as glycidyl methacrylate and a (meth)acryloyl group is allowed to act on a polymer having a carboxyl group; and (6) a process in which vinyl monomers each having a 3-chloropropionic acid ester moiety are polymerized, and then, dehydrochlorination is performed. In the invention, a (meth)acryloyl group is preferably introduced into a polymer having a hydroxyl group with the process (1) or (2) out of these processes.

When the composition ratio of the (meth)acryloyl group-containing repeating units is increased, the coating film strength is improved, but the refractive index is also increased. The (meth)acryloyl group-containing repeating units account for different proportions according to the kind of the repeating unit derived from the fluorine-containing vinyl monomer. However, in general, the repeating units preferably account for 5 to 90 mass %, more preferably account for 30 to 70 mass %, and in particular preferably account for 40 to 60 mass %.

For the copolymer useful for the invention, it is also possible to appropriately copolymerize other vinyl monomers than the repeating units derived from the fluorine-containing vinyl monomers and the repeating units each having a (meth)acryloyl group on the side chain from the various viewpoints including the adhesion to a base material, Tg of the polymer (which contributes to the film hardness), the solubility in a solvent, the transparency, the slipping property, and the dust proof and stain proof properties. These vinyl monomers may be used in combination of a plurality thereof according to the intended purpose, and these are introduced in a total amount preferably in the range of 0 to 65 mol %, more preferably in the range of 0 to 40 mol %, and in particular preferably in the range of 0 to 30 mol % based on the amount of the copolymer.

The vinyl monomer units usable in combination have no particular restriction. Examples thereof may include: olefins (such as ethylene, propylene, isoprene, vinyl chloride, and vinylidene chloride), acrylic acid esters (such as methyl acrylate, ethyl acrylate, 2-ethylhexyl acrylate, and 2-hydroxyethyl acrylate), methacrylic acid esters (methyl methacrylate, ethyl methacrylate, butyl methacrylate, and 2-hydroxyethyl methacrylate), styrene derivatives (such as styrene, p-hydroxymethylstyrene, and p-methoxystyrene), vinyl ethers (such as methyl vinyl ether, ethyl vinyl ether, cyclohexyl vinyl ether, hydroxyethyl vinyl ether, and hydroxybutyl vinyl ether), vinyl esters (such as vinyl acetate, vinyl propionate, and vinyl cinnamate), unsaturated carboxylic acids (such as acrylic acid, methacrylic acid, crotonic acid, maleic acid, and itaconic acid), acrylamides (such as N,N-dimethylacrylamide, N-tert-butylacrylamide, and N-cyclohexylacrylamide), and methacrylamides (N,N-dimethylmethacrylamide), and acrylonitrile.

As the preferred form of the copolymer to be used in the invention, mention may be made of the one of the following formula (1):

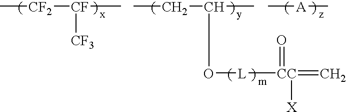

In the formula (1), L denotes a linking group having 1 to 10 carbon atoms; m denotes 0 or 1; X denotes a hydrogen atom or a methyl group; A denotes a repeating unit derived from a given vinyl monomer, and may comprise a single component or a plurality of components; and x, y, and z denote the mole percentages of their respective constituent components, and the values satisfying 30≦x≦60, 5≦y≦70, and 0≦z≦65, respectively.

In the formula (1), L denotes a linking group having 1 to 10 carbon atoms, and more preferably a linking group having 1 to 6 carbon atoms, and in particular preferably a linking group having 2 to 4 carbon atoms, which may have a straight chain or branched structure, or may have a ring structure, and may have a hetero atom selected from O, N, and S.

Preferred examples thereof may include: *—(CH₂)₂—O—**, *—(CH₂)₂—NH—**, *—(CH₂)₄—O—**, *—(CH₂)₆—O—**, * —(CH₂)₂—O—(CH₂)₂—O—**, *—CONH—(CH₂)₃—O—**, *—CH₂CH(OH)CH₂—O—**, and *—CH₂CH₂OCONH(CH₂)₃—O—** (* denotes the linking site on the polymer main chain side, and ** denotes the linking site on the (meth)acryloyl group side). m denotes 0 or 1.

In the formula (1), X denotes a hydrogen atom or a methyl group. A hydrogen atom is more preferred from the viewpoint of curing reactivity.

In the formula (1), A denotes a repeating unit derived from a given vinyl monomer, and has no particular restriction so long as it is a constituent component of a monomer copolymerizable with hexafluoropropylene. It can be appropriately selected from various viewpoints including the adhesion to a base material, the Tg of the polymer (which contributes to the film hardness), the solubility in a solvent, the transparency, the slipping property, and the dust proof and stain proof properties. It may comprise a single vinyl monomer or a plurality of vinyl monomers according to the intended purpose.

Preferred examples thereof may include: vinyl ethers such as methyl vinyl ether, ethyl vinyl ether, t-butyl vinyl ether, cyclohexyl vinyl ether, isopropyl vinyl ether, hydroxyethyl vinyl ether, hydroxybutyl vinyl ether, glycidyl vinyl ether, and allyl vinyl ether, vinyl esters such as vinyl acetate, vinyl propionate, and vinyl butyrate, methacrylates such as methyl(meth)acrylate, ethyl(meth)acrylate, hydroxyethyl(meth)acrylate, glycidyl methacrylate, allyl(meth)acrylate, and (meth)acryloyloxypropyl trimethoxysilane, styrene derivatives such as styrene and p-hydroxymethylstyrene, and unsaturated carboxylic acids such as crotonic acid, maleic acid, and itaconic acid, and derivatives thereof. Vinyl ether derivatives and vinyl ester derivatives are more preferred, and vinyl ether derivatives are particularly preferred.

x, y, and z denote the mole percentages of their respective constituent components, and denote the values satisfying 30≦x≦60, 5≦y≦70, and 0≦z≦65, respectively. The case where 35≦x≦55, 30≦y≦60, and 0≦z≦20 is preferred. The case where 40≦x≦55, 40≦y≦55, and 0≦z≦10 is particularly preferred.

As the particularly preferred form of the copolymer for use in the invention, mention may be made of the one of the following formula (2):

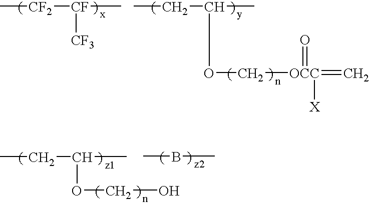

In the formula (2), X, x, and y are the same as those described for the formula (1); B denotes a repeating unit derived from a given vinyl monomer, and may comprise a single component or a plurality of components; z1 and z2 denote the mole percentages of their respective constituent components, and denote the values satisfying 0≦z1≦65 and 0≦z2≦65, respectively; and n denotes an integer satisfying 2≦n≦10.

In the formula (2), X, x, and y denotes the same as those in the formula (1), and the preferred ranges thereof are also respectively the same.

n denotes an integer satisfying 2≦n≦10. 2≦n≦6 is preferred, and 2≦n≦4 is particularly preferred.

B denotes a repeating unit derived from a given vinyl monomer, and may comprise a single composition or a plurality of compositions. Examples thereof correspond to those exemplified for A in the formula (1).

Z1 and Z2 denote the mole percentages of their respective constituent components, and denote the values satisfying 0≦z1≦65 and 0≦z2≦65, respectively. These satisfy preferably 0≦z1≦30 and 0≦z2≦10, respectively, and in particular preferably 0≦z1≦10 and 0≦z2≦5, respectively.

The copolymer represented by the formula (1) or (2) can be synthesized, for example, by introducing a (meth)acryloyl group into a copolymer comprising a hexafluoropropylene component and a hydroxyalkyl vinyl ether component with any of the aforementioned processes.

Non-limiting preferred examples of the copolymer useful in the invention will be shown below.

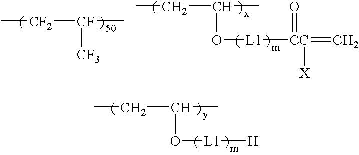

| | x | y | m | L1 | X |
|---|---|---|---|---|---|
| P-1 | 50 | 0 | 1 | *—CH₂CH₂O—** | H |
| P-2 | 50 | 0 | 1 | *—CH₂CH₂O—** | CH₃ |
| P-3 | 45 | 5 | 1 | *—CH₂CH₂O—** | H |
| P-4 | 40 | 10 | 1 | *—CH₂CH₂O—** | H |
| P-5 | 30 | 20 | 1 | *—CH₂CH₂O—** | H |
| P-6 | 20 | 30 | 1 | *—CH₂CH₂O—** | H |
| P-7 | 50 | 0 | 0 | — | H |
| P-8 | 50 | 0 | 1 | *—C₄H₈O—** | H |
| P-9 | 50 | 0 | 1 | 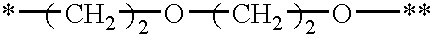 | H |
| P-10 | 50 | 0 | 1 | 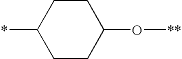 | H |

*denotes the polymer main chain side, and **denotes the (meth)acryloyl group side.

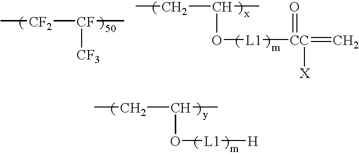

| | x | y | m | L1 | X |
|---|---|---|---|---|---|
| P-11 | 50 | 0 | 1 | *—CH₂CH₂NH—** | H |
| P-12 | 50 | 0 | 1 | 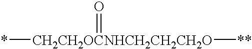 | H |
| P-13 | 50 | 0 | 1 | 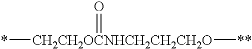 | CH₃ |
| P-14 | 50 | 0 | 1 | 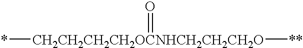 | CH₃ |
| P-15 | 50 | 0 | 1 | 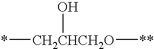 | H |
| P-16 | 50 | 0 | 1 | 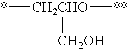 | H |
| P-17 | 50 | 0 | 1 | 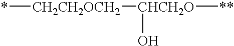 | H |
| P-18 | 50 | 0 | 1 | 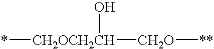 | CH₃ |
| P-19 | 50 | 0 | 1 | 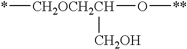 | CH₃ |
| P-20 | 40 | 10 | 1 | *—CH₂CH₂O—** | CH₃ |

*denotes the polymer main chain side, and **denotes the (meth)acryloyl group side.

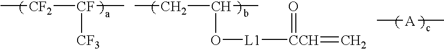

| | a | b | c | L1 | A |
|---|---|---|---|---|---|
| P-21 | 55 | 45 | 0 | *—CH₂CH₂O—** | — |
| P-22 | 45 | 55 | 0 | *—CH₂CH₂O—** | — |
| P-23 | 50 | 45 | 5 | 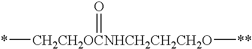 | 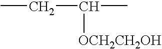 |
| P-24 | 50 | 45 | 5 | 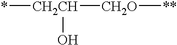 | 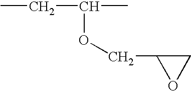 |
| P-25 | 50 | 45 | 5 | 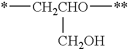 | 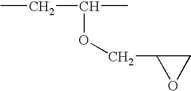 |
| P-26 | 50 | 40 | 10 | *—CH₂CH₂O—** | 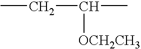 |
| P-27 | 40 | 40 | 10 | *—CH₂CH₂O—** | 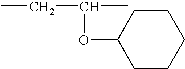 |
| P-28 | 50 | 40 | 10 | *—CH₂CH₂O—** | 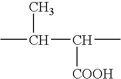 |

*denotes the polymer main chain side, and **denotes the (meth)acryloyl group side.

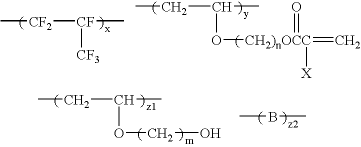

| | x | y | z1 | z2 | n | X | B |
|---|---|---|---|---|---|---|---|
| P-29 | 50 | 40 | 5 | 5 | 2 | H | 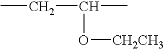 |
| P-30 | 50 | 35 | 5 | 10 | 2 | H | 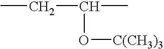 |
| P-31 | 40 | 40 | 10 | 10 | 4 | CH₃ | 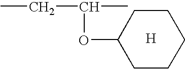 |

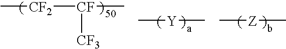

| | a | b | Y | Z |
|---|---|---|---|---|
| P-32 | 45 | 5 | 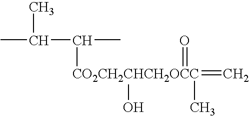 | 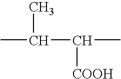 |
| P-33 | 40 | 10 | 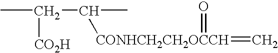 | 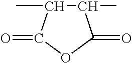 |

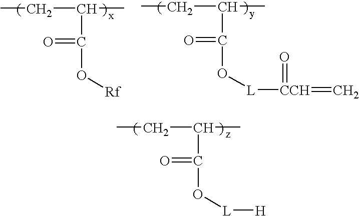

| | x | y | z | Rf | L |
|---|---|---|---|---|---|
| P-34 | 60 | 40 | 0 | —CH₂CH₂C₈F₁₇-n | —CH₂CH₂O— |
| P-35 | 60 | 30 | 10 | —CH₂CH₂C₄F₈H-n | —CH₂CH₂O— |
| P-36 | 40 | 60 | 0 | —CH₂CH₂C₆F₁₂H | —CH₂CH₂CH₂CH₂O— |

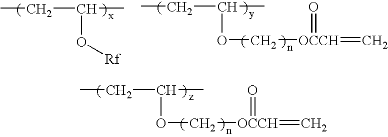

| | x | y | z | n | Rf |
|---|---|---|---|---|---|
| P-37 | 50 | 50 | 0 | 2 | —CH₂C₄F₈H-n |
| P-38 | 40 | 55 | 5 | 2 | —CH₂C₄F₈H-n |
| P-39 | 30 | 70 | 0 | 4 | —CH₂C₈F₁₇-n |
| P-40 | 50 | 40 | 0 | 2 | —CH₂CH₂C₈F₁₆H-n |

The synthesis of the copolymer for use in the invention can be carried out in the following manner. A precursor such as a hydroxyl group-containing polymer is synthesized with various polymerization methods of, for example, solution polymerization, precipitation polymerization, suspension polymerization, bulk polymerization, and emulsion polymerization. Then, a (meth)acryloyl group is introduced thereto by the polymer reaction. The polymerization reaction can be carried out through known operations of batch, semi-continuous, continuous, and other types.

The methods for initiating polymerization include a method using a radical initiator, a method in which light or radiation is applied, and other methods. These polymerization methods and the methods for initiating polymerization are described, for example, in Teiji Tsuruta, Polymer Synthesis Method (KOUBUNSHI GOSEI HOUHOU), revised edition, (published by The Nikkan Kogyo Shimbun, Ltd., 1971), and Experiment Method of Polymer Synthesis (KOUBUNSHI GOUSEI NO JIKKEN HOUHOU) written by Takayuki Ootsu and Masaetsu Kinoshita, and published by Kagaku-Dojin Publishing Company, INC., 1972, pages 124 to 154.

Out of the above-described polymerization methods, the solution polymerization method using a radical initiator is particularly preferred. Examples of the solvent for use in the solution polymerization method may include: various organic solvents such as ethyl acetate, butyl acetate, acetone, methyl ethyl ketone, methyl isobutyl ketone, cyclohexanone, tetrahydrofuran, dioxane, N,N-dimethylformamide, N,N-dimethylacetamide, benzene, toluene, acetonitrile, methylene chloride, chloroform, dichloroethane, methanol, ethanol, 1-propanol, 2-propanol, and 1-butanol, which may be used singly or as a mixture of two or more thereof, or further may be used as a mixed solvent with water.

The polymerization temperature is required to be set in association with the molecular weight of a resultant polymer, the kind of the initiator, and the like. It may be 0° C. or less to 100° C. or more. However, polymerization is preferably carried out at a temperature in the range of 50 to 100° C.

The reaction pressure can be appropriately selected. It is generally 1 to 100 kg/cm², and in particular desirably about 1 to 30 kg/cm². The reaction time is about 5 to 30 hours.

The solvent for reprecipitation of the resultant polymer is preferably isopropanol, hexane, methanol, or the like.

The low refractive index layer forming composition of the invention generally takes on a liquid form, and contains the copolymer as an essential constitutional component. It is manufactured by, if required, dissolving various additives and a radical polymerization initiator in an appropriate solvent. At this step, the concentration of solid contents is appropriately selected according to the intended purpose. It is generally about 0.01 to 60 mass %, preferably 0.5 to 50 mass %, and in particular preferably about 1 mass % to 20 mass %.

As described above, it is not necessarily advantageous from the viewpoint of the film hardness of the low refractive index layer to add additives such as a hardening agent. However, from the viewpoint of the interface adhesion to the high refractive index layer, and other viewpoints, it is also possible to add a hardening agent such as a multifunctional (meth)acrylate compound, a multifunctional epoxy compound, a polyisocyanate compound, aminoplast, or a polybasic acid or an anhydride thereof, or inorganic fine particles of silica or the like in small amounts. When these are added, these are added in an amount preferably in the range of 0 to 30 mass %, more preferably 0 to 20 mass %, and in particular preferably 0 to 10 mass % based on the total solid content of the low refractive index layer film.

Whereas, it is also possible to appropriately add a known silicone-containing or fluorine-containing stain-proofing agent, a slipping agent, and the like for the purpose of imparting the characteristics such as the stain proof property, the water resistance, the chemical resistance, and the slipping property. When these additives are added, these are preferably added in an amount in the range of 0 to 20 mass %, and more preferably added in an amount in the range of 0 to 10 mass %, and in particular preferably 0 to 5 mass % based on the total solid content of the low refractive index layer.

The radical initiator may take on either form of the one generating radicals by the action of heat and the one generating radicals by the action of light.

As the compounds initiating the radical polymerization by the action of heat, organic or inorganic peroxides, organic azo and diazo compounds, and the like are usable.

Specifically, mention may be made of: organic peroxides such as benzoyl peroxide, halogen benzoyl peroxide, lauroyl peroxide, acetyl peroxide, dibutyl peroxide, cumene hydroperoxide, and butyl hydroperoxide, inorganic peroxides such as hydrogen peroxide, ammonium persulfate, and potassium persulfate, azo compounds such as 2-azo-bis-isobutyronitrile, 2-azo-bis-propionitrile, and 2-azo-bis-hexanedinitrile, diazo compounds such as diazoaminobenzene and p-nitrobenzene diazonium, and the like.

When the compound initiating radical polymerization by the action of light is used, curing of the film is carried out through irradiation with an active energy ray.

Examples of such a radical photopolymerization initiator may include: acetophenones, benzoins, benzophenones, phosphine oxides, ketals, anthraquinones, thioxanthones, azo compounds, peroxides, 2,3-dialkyldione compounds, disulfide compounds, fluoroamine compounds, and aromatic sulfoniums. Examples of acetophenone may include: 2,2-diethoxyacetophenone, p-dimethylacetophenone, 1-hydroxydimethyl phenyl ketone, 1-hydroxycyclohexyl phenyl ketone, 2-methyl-4-methylthio-2-morpholinopropiophenone, and 2-benzyl-2-dimethylamino-1-(4-morpholinophenyl)-butanone. Examples of benzoins may include: benzoin benzenesulfonic acid ester, benzoin toluenesulfonic acid ester, benzoin methyl ether, benzoin ethyl ether, and benzoin isopropyl ether. Examples of benzophenones may include: benzophenone, 2,4-dichlorobenzophenone, 4,4-dichlorobenzophenone, and p-chlorobenzophenone. Examples of phosphine oxides may include 2,4,6-trimethylbenzoyl diphenylphosphine oxide. It is also possible to preferably use a sensitizing dye in combination with these radical photopolymerization initiators.

It is essential only that the amount of, the compound initiating radical polymerization by the action of heat or light, to be added is the amount capable of initiating the polymerization of carbon-carbon double bonds. In general, the amount is preferably 0.1- to 15 mass %, more preferably 0.5 to 10 mass %, and in particular preferably 2 to 5 mass % based on the total solid content in the low refractive index layer forming composition.

The solvent contained in the low refractive index layer coating solution composition has no particular restriction so long as it can uniformly dissolve or disperse a composition containing a fluorine-containing copolymer therein without causing precipitation. Two or more solvents may also be used in combination. Preferred examples thereof may include: ketones (such as acetone, methyl ethyl ketone, and methyl isobutyl ketone), esters (such as ethyl acetate and butyl acetate), ethers (such as tetrahydrofuran and 1,4-dioxane), alcohols (such as methanol, ethanol, isopropyl alcohol, butanol, and ethylene glycol), aromatic hydrocarbons (such as toluene and xylene), and water.

The low refractive index layer may contain, other than the fluorine-containing compounds, fillers (e.g., inorganic fine particles and organic fine particles), a silane coupling agent, a slipping agent (a silicone compound such as dimethyl silicone, and the like), a surfactant, and the like. Particularly, it preferably contains inorganic fine particles, a silane coupling agent, and a slipping agent.

The inorganic fine particles are preferably silicon dioxide (silica) fine particles, fluorine-containing particles (magnesium fluoride, potassium fluoride, and barium fluoride particles), and the like. Silicon dioxide (silica) fine particles are particularly preferred. The mass average diameter of primary particles of the inorganic fine particles is preferably 1 to 150 nm, more preferably 1 to 100 nm, and most preferably 1 to 80 nm. The inorganic fine particles are preferably dispersed more finely in the outermost layer. The shape of the inorganic fine particle is preferably a rice-grain shape, a spherical shape, a cubic shape, a spindle shape, a staple fiber shape, a ring shape, or an indefinite shape.

As the silane coupling agent, the compound represented by the formula A, and/or a derivative compound thereof can be used. It is preferably a silane coupling agent containing a hydroxyl group, a mercapto group, a carboxyl group, an epoxy group, an alkyl group, an alkoxysilyl group, an acyloxy group, or an acylamino group. It is in particular preferably a silane coupling agent containing an epoxy group, a polymerizable acyloxy group ((meth)acryloyl), or a polymerizable acylamino group (acrylamino or methacrylamino).

The compound represented by the formula A is in particular preferably a compound having a (meth)acryloyl group as a crosslinkable or polymerizable functional group. Examples thereof may include: 3-acryloxypropyl trimethoxysilane and 3-methacryloxypropyl trimethoxysilane.

The slipping agents are preferably dimethyl silicone and a fluorine-containing compound having a polysiloxane segment introduced therein.

The low refractive index layer is preferably formed in the following manner. A coating composition which has dissolved or dispersed therein a fluorine-containing compound, and other given components to be contained, if required, is coated. Simultaneously with coating, or after coating, a crosslinking reaction or a polymerization reaction is effected though irradiation with light, irradiation with an electron beam, or through heating.

Particularly when the low refractive index layer is formed by the crosslinking reaction or the polymerization reaction of an ionizing radiation-curable compound, the crosslinking reaction or the polymerization reaction is preferably carried out in an atmosphere with an oxygen concentration of 10% by volume or less. By forming the low refractive index layer in an atmosphere with an oxygen concentration of 10% by volume or less, it is possible to obtain the outermost layer excellent in physical strengths and chemical resistance.

The oxygen concentration is preferably 6% by volume or less, the oxygen concentration is further preferably 4% by volume or less, and the oxygen concentration is in particular preferably 2% by volume or less, and most preferably 1% by volume or less.

The oxygen concentration is set at 10% by volume or less preferably in the following manner. The air (nitrogen concentration: about 79% by volume, oxygen concentration: about 21% by volume) is preferably replaced with another gas, and in particular preferably replaced with nitrogen (purged with nitrogen).

[Hard Coat Layer]

A hard coat layer of the antireflection film of the invention is provided on the surface of the transparent support in order to impart physical strengths to the antireflection film. Particularly, it is preferably provided between the transparent support and the high refractive index layer.

The hard coat layer is preferably formed by the crosslinking reaction or the polymerization reaction of an ionizing radiation-curable compound. For example, it can be formed by coating a coating composition containing ionizing radiation-curable multifunctional monomers and multifunctional oligomers on the transparent support, and effecting the crosslinking reaction or the polymerization reaction of the multifunctional monomers and multifunctional oligomers.

The functional groups of ionizing radiation-curable multifunctional monomers and multifunctional oligomers are preferably photo-, electron beam, or radiation polymerizable functional groups. Out of these, photopolymerizable functional groups are preferred.

As the photopolymerizable functional groups, mention may be made of unsaturated polymerizable functional groups such as a (meth)acryloyl group, a vinyl group, a styryl group, and an allyl group, and the like. Out of these, a (meth)acryloyl group is preferred.

Specific examples of the photopolymerizable multifunctional monomers having a photopolymerizable functional group may include those exemplified for the high refractive index layer, which are preferably polymerized using a photopolymerization initiator and a photosensitizer. The photopolymerization reaction is preferably carried out through ultraviolet irradiation after coating and drying of the hard coat layer.

To the hard coat layer, inorganic fine particles with an average particle diameter of 0.001 to 0.1 μm are preferably added in order to impart the physical strengths thereto.

Specific examples of the inorganic fine particles may include particles of silicon dioxide, titanium dioxide, zirconium oxide, aluminum oxide, tin oxide, ITO, zinc oxide, and calcium carbonate. The smaller the difference in refractive index from the binder is, the more the scattering of light is reduced. For this reason, silicon dioxide or aluminum oxide is preferably used.

The amount of the inorganic fine particles to be added is preferably about 5 to 50 mass %. When the amount is too large, brittleness is insufficient. Whereas, when the amount is too small, the effects of addition of the inorganic fine particles are insufficient.

To the hard coat layer, an oligomer and/or polymer with an weight-average molecular weight of 500 or more is preferably added in order to impart the brittleness thereto according to the intended purpose.

As the oligomers and the polymers, mention may be made of (meth)acrylate type, cellulose type, and styrene type polymers, urethane acrylate, polyester acrylate, and the like. Preferably, mention may be made of poly(glycidyl(meth)acrylate) and (allyl(meth)acrylate) having functional groups at side chains, and the like.

The content of the oligomer and/or polymer in the hard coat layer is preferably 5 to 50 mass %, more preferably 15 to 40 mass %, and in particular preferably 20 to 30 mass % based on the total mass of the hard coat layer.

As described above, the high refractive index layer is capable of also serving as the hard coat layer. When the high refractive index layer also serves as the hard coat layer, the layer is preferably formed by finely dispersing inorganic fine particles with a high refractive index in the hard coat layer, and thereby allowing the fine particles to be contained therein with the technique described for the high refractive index layer.

The hard coat layer may also be allowed to further contain particles with an average particle diameter of 0.2 to 10 μm described later, thereby to also serve as an antiglare layer which has acquired an antiglare function.

The thickness of the hard coat layer can be properly designed according to the intended purpose. The thickness of the hard coat layer is preferably 0.2 to 10 μm, more preferably 1 to 9 μm, and in particular preferably 5 to 8 μm.

The strength of the hard coat layer is preferably H or more, further preferably 2H or more, and most preferably 3H or more in the pencil hardness test according to JIS K5400.

Whereas, with the Taber test according to JIS K5400, a smaller amount of abrasion loss of a test piece before and after the test is preferred.

For the formation of the hard coat layer, when it is formed by the crosslinking reaction or the polymerization reaction of an ionizing radiation-curable compound, the crosslinking reaction or the polymerization reaction is preferably carried out in an atmosphere with an oxygen concentration of 10% by volume or less. By forming the layer in an atmosphere with an oxygen concentration of 10% by volume or less, it is possible to form the hard coat layer excellent in physical strengths and chemical resistance.

The layer is formed by the crosslinking reaction or the polymerization reaction of an ionizing radiation-curable compound in an atmosphere preferably with an oxygen concentration of 6% by volume or less, further preferably with an oxygen concentration of 4% by volume or less, in particular preferably with an oxygen concentration of 2% volume or less, and most preferably 1% by volume or less.

The oxygen concentration is set at 10% by volume or less in the following manner. The air (nitrogen concentration: about 79% by volume, oxygen concentration: about 21% by volume) is preferably replaced with another gas, and in particular preferably replaced with nitrogen (purged with nitrogen).

The hard coat layer is preferably formed by coating a coating composition for forming the hard coat layer on the surface of the transparent support.

The coating solvents are preferably ketone type solvents exemplified for the high refractive index layer. By using a ketone type solvent, the adhesion between the surface of the transparent support (particularly, a triacetyl cellulose support) and the hard coat layer is further improved.

Particularly preferred coating solvents are methyl ethyl ketone, methyl isobutyl ketone, and cyclohexanone.

The coating solvents may contain solvents other than the ketone type solvents exemplified for the high refractive index layer.

In the coating solvent, the content of the ketone type solvent is preferably 10 mass % or more based on the total amount of solvents contained in the coating composition. It is preferably 30 mass % or more, and further preferably 60 mass % or more.

[Surface Irregularities of Antireflection Film]

The antireflection film for use in the invention can also have irregularities formed in the surface on the side having the high refractive index layer, and thereby acquire antiglare property.

The antiglare property correlates with the average surface roughness (Ra). The irregularities of the surface are preferably such that the average surface roughness (Ra) is, when a 1-mm² area is taken out of a 100-cm² area at random, preferably 0.01 to 0.4 μm, more preferably 0.03 to 0.3 μm, further preferably 0.05 to 0.25 μm, and in particular preferably 0.07 to 0.2 μm per 1-mm² area of the surface taken.

The average surface roughness (Ra) is described in TECHNO COMPACT SERIES (6) (Measurement/Evaluation Method of Surface Roughness (HYOUMEN ARASANO SKUTEI•HYOUHAHOU), author; JIROU NARA, Publisher; Sougou Gijyutu Center Co., Ltd.).

It is possible to evaluate the shape of the irregularities of the surface of the antireflection film for use in the invention by an atomic force microscope (AFM).

As the methods for forming the irregularities of the surface, known methods may be used. In the invention, preferred are a method in which the irregularities are formed by pressing a plate having the shape of irregularities against the surface of the film under a high pressure (e.g., embossing), and a method in which any layer of the antireflection film is allowed to contain particles to serve as an antiglare layer, thereby to form irregularities in the surface of the antireflection film.

To the methods for forming irregularities in the surface by embossing, known techniques are applicable. However, it is particularly preferable to form the irregularities by the technique described in JP-A-2000-329905.

When any layer of the antireflection film is allowed to contain particles to form the antiglare layer, the particles to be used for the antiglare layer are preferably particles with an average particle diameter of 0.2 to 10 μm. The average particle diameter herein referred to is the mass average diameter of the secondary particles (the primary particles when particles do not flocculate).

As the particles, mention may be made of inorganic particles and organic particles. Specific examples of the inorganic particles may include particles of silicon dioxide, titanium dioxide, zirconium oxide, aluminum oxide, tin oxide, ITO, zinc oxide, calcium carbonate, barium sulfate, talk, kaolin, calcium sulfate, and the like. Silicon dioxide and aluminum oxide are preferred.

The organic particles are preferably resin particles. Specific examples of resin particles may include particles produced from silicon resin, melamine resin, benzoguanamine resin, polymethyl methacrylate resin, polystyrene resin, and polyvinylidene fluoride. The particles produced from melamine resin, benzoguanamine resin, polymethyl methacrylate resin, and polystyrene resin are preferred. The particles produced from polymethyl methacrylate resin, benzoguanamine resin, and polystyrene resin are particularly preferred.

The particles to be used for the antiglare layer in order to form irregularities are preferably resin particles.

The average particle diameter of the particles is preferably 0.5 to 7.0 μm, further preferably 1.0 to 5.0 μm, and in particular preferably 1.5 to 4.0 μm.

The refractive index of the particles is preferably 1.35 to 1.80, more preferably 1.40 to 1.75, and further preferably 1.45 to 1.75.

A smaller particle diameter distribution of the particles is preferred. The S value indicative of the particle diameter distribution of the particles is represented by the following equation, and it is preferably 2 or less, further preferably 1.0 or less, and in particular preferably 0.7 or less.
S=[S(0.9)−D(0.1)]/D(0.5)

D(0.1): 10% equivalent particle diameter of the integrated value of volume-equivalent particle diameter;

D(0.5): 50% equivalent particle diameter of the integrated value of volume-equivalent particle diameter; and

D(0.9): 90% equivalent particle diameter of the integrated value of volume-equivalent particle diameter Whereas, the refractive index of the particles has no particular restriction. However, preferably, it is roughly the same as the refractive index of the antiglare layer (the difference in refractive index being within 0.005), or it is different by 0.02 or more.

By roughly equalizing the refractive index of the particles and the refractive index of the antiglare layer, the contrast when the antireflection film is mounted on the image display surface is improved.

By causing a difference between the refractive index of the particles and the refractive index of the antiglare layer, the visibility (such as glaring failure or viewing angle characteristic) when the antireflection film is mounted on the liquid crystal display surface is improved.

When a difference is caused between the refractive index of the particles and the refractive index of the antiglare layer, it is preferably 0.03 to 0.5, more preferably 0.03 to 0.4, and in particular preferably 0.05 to 0.3.

The particles for imparting the antiglare property can be contained in any layer formed in the antireflection film. The particles are added to preferably the hard coat layer, the low refractive index layer, or the high refractive index layer, and in particular preferably the hard coat layer or the high refractive index layer. The particles may also be added to a plurality of the layers.

[Other Layers of Antireflection Film]

In order to manufacture an antireflection film having a more excellent antireflection performance, an intermediate refractive index layer having a refractive index between the refractive index of the high refractive index layer and the refractive index of the transparent support is preferably provided.

The intermediate refractive index layer is preferably manufactured in the same manner as described for the high refractive index layer of the invention. The adjustment of the refractive index is possible by controlling the content of inorganic fine particles in the film.

In the antireflection film, layers other than the aforementioned layers may also be provided. For example, an adhesion layer, a shielding layer, a slipping layer, and an antistatic layer may also be provided. The shielding layer is provided for shielding against an electromagnetic wave or an infrared ray.

Whereas, when the antireflection film is applied to a liquid crystal display device, it is possible, for the purpose of improving the viewing angle characteristics, to newly form an undercoat layer to which particles with an average particle diameter of 0.1 to 10 μm have been added, or to add the particles into the hard coat layer, thereby making it a light scattering hard coat layer. The average particle diameter of the particles is preferably 0.2 to 5.0 μm, further preferably 0.3 to 4.0 μm, and in particular preferably 0.5 to 3.5 μm.

The refractive index of the particles is preferably 1.35 to 1.80, more preferably 1.40 to 1.75, and further preferably 1.45 to 1.75.

A smaller particle diameter distribution of the particles is preferred. The S value indicative of the particle diameter distribution of the particles is represented by the above-described equation, and it is preferably 1.5 or less, further preferably 1.0 or less, and in particular preferably 0.7 or less.

Whereas, the difference in refractive index between the particles and the undercoat layer is preferably 0.02 or more. More preferably, the difference in refractive index is 0.03 to 0.5, further preferably the difference in refractive index is 0.05 to 0.4, and in particular preferably, the difference in refractive index is 0.07 to 0.3.

As the particles to be added to the undercoat layer, mention may be made of the inorganic particles and the organic particles described for the antiglare layer.

The undercoat layer is preferably formed between the hard coat layer and the transparent support. Further, it can also serve as a hard coat layer.

When particles having an average particle diameter of 0.1 to 10 μm are added to the undercoat layer, the haze of the undercoat layer is preferably 3 to 60%. It is more preferably 5 to 50%, further preferably 7 to 45%, and in particular preferably 10 to 40%.

[Method for Forming Antireflection Film, and the Like]

Each layer of the antireflection film can be formed by a coating process such as a wire bar coating process, a gravure coating process, a micro gravure process, or a die coating process. A micro gravure process and a gravure process are preferred from the viewpoint of minimizing the wet coating amount, and thereby eliminating the drying unevenness. Particularly preferred is a forward gravure process in which a support is uniformly nipped between a plate cylinder and an impression cylinder at a coating site from the viewpoints of the film thickness uniformity along the width direction and the film thickness uniformity along the length direction over time after coating, or a reverse micro gravure process configured such that the coating solution scraping pressure of a blade is less likely to fluctuate along the width direction and along the length direction. It is preferable from the viewpoint of the manufacturing cost to form at least two layers of a plurality of optical thin films of the antireflection film of the invention by steps of single feeding of a support film, formation of the respective optical thin films, and winding of the film. When the antireflection film is three layer structured, it is more preferable to form the three layers in a single step. Such a manufacturing process can be accomplished by providing a plurality of sets of coating stations, and drying and curing zones, and preferably the sets as many as, or more than the number of the optical thin films in tandem.

One example of the apparatus configuration is shown in FIG. 2. FIG. 2 shows an example in which a first coating station (102), a first drying zone (103), a first UV irradiation device (104), a second coating station (105), a second drying zone (106), a second UV irradiation device (107), a third coating station (108), a third drying zone (109), a third UV irradiation device (110), and a post drying zone (111) are included in the area from a feeder (101) to a winder (112) for a roll film where one process between feeding and winding is completed. This can form up to three layers of functional layers such as the three layers of the intermediate refractive index layer, the high refractive index layer, and the low refractive index layer, the three layers of the hard coat layer, the high refractive index layer, and the low refractive index layer, or the three layers of the hard coat layer, the antiglare layer, and the low refractive index layer in one process. As other preferred forms, mention may be made of the forms adopting the following manufacturing processes: a process in which, if required, with an apparatus configuration in which the number of the coating stations has been reduced to two, only two layers of the intermediate refractive index layer and the high refractive index layer are formed in one process, and the checking results of the surface conditions, thickness, and the like are feedbacked to improve the yield, or an antiglare antireflection film comprising two layers of an antiglare layer and a low refractive index layer is manufactured at a low cost; and another process in which, with an apparatus configuration in which the number has been increased to 4, the hard coat layer, the intermediate refractive index layer, the high refractive index layer, and the low refractive index layer are formed in one process, resulting in a large reduction in coating cost. Whereas, the post drying zone (111) also serves to promote curing when a thermosetting material is used as a main raw material, and hence it is not necessarily required when an ionizing radiation-curable resin is used as a main raw material.

[Surface of Antireflection Film]

In the invention, for the antireflection film, the kinetic friction coefficient of the surface on the side having the high refractive index layer is preferably 0.25 or less in order to improve the physical strengths (such as abrasion resistance). The kinetic friction coefficient herein referred to denotes the kinetic friction coefficient between the surface on the side having the high refractive index layer and a 5 mm-dia rigid stainless steel ball when the 5 mm-dia rigid stainless steel ball is moved on the surface on the side having the high refractive index layer under a load of 0.98 N at a speed of 60 cm/min. It is preferably 0.17 or less, and in particular preferably 0.15 or less.

Whereas, for the antireflection film, the contact angle to water of the surface on the side having the high refractive index layer is preferably 90° or more, further preferably 95° or more, and in particular preferably 100° or more in order to improve the stain proof property.

When the antireflection film does not have an antiglare function, a lower haze is preferred.

When the antireflection film has an antiglare function, the haze is preferably 0.5 to 50%, further preferably 1 to 40%, and most preferably 1 to 30%.

[Configuration of Antireflection Film]

An example of a configuration of the antireflection film of the invention will be described by reference to the drawings.

FIG. 1 is a cross sectional view schematically showing the layer configuration of the antireflection film having an excellent antireflection performance. The antireflection film has a layer configuration of a transparent support 1, a hard coat layer 2, an intermediate refractive index layer 3, a high refractive index layer 4, and a low refractive index layer (outermost layer) 5 in this order. The transparent support 1, the intermediate refractive index layer 3, the high refractive index layer 4, and the low refractive index layer 5 have their respective refractive indexes satisfying the following relationship.

Refractive index of high refractive index layer>Refractive index of intermediate refractive index layer>Refractive index of transparent support>Refractive index of low refractive index layer

For the layer configuration as shown in FIG. 1, as described in JP-A-59-50401, it is preferable that the intermediate refractive index layer, the high refractive index layer, and the low refractive index layer satisfy the following mathematical expression (I), mathematical expression (II), and mathematical expression (III), respectively, because an antireflection film having a more excellent antireflection performance can be manufactured.
(hλ/4)×0.7<n₃d₃<(hλ/4)×1.3 Mathematical expression (I);

In the mathematical expression (I), h is a positive integer (generally, 1, 2, or 3), n₃ is the refractive index of the intermediate refractive index layer, and d₃ is the layer thickness (nm) of the intermediate refractive index layer. λ is the wavelength (nm) of a visible light, and is a value within a range of 380 to 680 nm.
(iλ/4)×0.7<n₄d₄<(iλ/4)×1.3 Mathematical expression (II);

In the mathematical expression (II), i is a positive integer (generally, 1, 2, or 3), n₄ is the refractive index of the high refractive index layer, and d₄ is the layer thickness (nm) of the high refractive index layer. λ is the wavelength (nm) of a visible light, and is a value within a range of 380 to 680 nm.
(jλ/4)×0.7<n₅d₅<(jλ/4)×1.3 Mathematical expression (III);

In the mathematical expression (III), j is a positive odd number (generally, 1), n₅ is the refractive index of the low refractive index layer, and d₅ is the layer thickness (nm) of the low refractive index layer. λ is the wavelength (nm) of a visible light, and is a value within a range of 380 to 680 nm.

For the layer configuration as shown in FIG. 1, it is particularly preferable that the intermediate refractive index layer, the high refractive index layer, and the low refractive index layer satisfy the following mathematical expression (IV), mathematical expression (V), and mathematical expression (VI), respectively.

Herein, λ is 500 nm, h is 1, and j is 1.
(hλ/4)×0.80<n₃d₃<(hλ/4)×1.00 Mathematical expression (IV);
(iλ/4)×0.75<n₄d₄<(iλ/4)×0.95 Mathematical expression (V);
(jλ/4)×0.95<n₅d₅<(jλ/4)×1.05 Mathematical expression (VI);

It is also preferable that the hard coat layer, the intermediate refractive index layer, and the high refractive index layer are allowed to contain particles having an average particle diameter of 0.2 to 10 μm to manufacture an antireflection film having an antiglare function.

[Protective Film for Polarizing Plate]

For forming a polarizing plate of the invention, in order to use the antireflection film as a surface protective film of the polarizing film (a protective film for the polarizing plate), it is essential to improve the adhesion in the adhesion surface by making hydrophilic the surface of the transparent support opposite to the side having an antireflection structure, i.e., the surface on the side to be bonded to the polarizing film.

As the transparent support of the antireflection film, a triacetyl cellulose film is in particular preferably used.

As the techniques for manufacturing a protective film for a polarizing plate in the invention, the following two techniques are conceivable: (1) a technique in which the respective layers (e.g., the high refractive index layer, the hard coat layer, and the outermost layer) are coated on one side of the transparent support previously subjected to a saponification treatment; and (2) a technique in which the respective layers (e.g., the high refractive index layer, the hard coat layer, and the outermost layer) are coated on one side of the transparent support, and then the side to be bonded to the polarizing film is subjected to a saponification treatment. With the technique (1), even the side to be coated with a hard coat is made hydrophilic. This makes it difficult to ensure the adhesion between the support and the hard coat layer. For this reason, the technique (2) is preferred.

[Saponification Treatment]

(1) Dipping Method

A dipping method is a method in which an antireflection film is dipped in an alkali solution under proper conditions, so that all the sides having an reactivity with alkalis in the whole surface of the film are subjected to a saponification treatment. This method does not require specific facilities, and hence it is preferred from the viewpoint of the cost. The alkali solution is preferably a sodium hydroxide aqueous solution. The concentration is preferably 0.5 to 3 mol/l, and in particular preferably 1 to 2 mol/l. The solution temperature of the alkali solution is preferably 30 to 70° C., and in particular preferably 40 to 60° C.

The combination of the saponification conditions is preferably the combination of relatively moderate conditions. However, it can be set according to the material and the configuration of the antireflection film, and the objective contact angle.

After dipping the film in the alkali solution, preferably, the film is sufficiently washed with water or dipped in a dilute acid to neutralize alkali components so that the alkali components do not remain in the film.

The surface of the transparent support opposite to the surface having the antireflection layer is made hydrophilic by being subjected to a saponification treatment. The protective film for a polarizing plate is used in such a manner that the hydrophilized surface of the transparent support is bonded to the polarizing film.

The hydrophilized surface is effective for improving the adhesion to an adhesion layer containing polyvinyl alcohol as a main component.

For the saponification treatment, a lower contact angle to water of the surface of the transparent support opposite to the side having the high refractive index layer is preferred from the viewpoint of the adhesion to the polarizing film. On the other hand, with the dipping method, even the surface having the high refractive index layer is damaged simultaneously by alkali, and hence it is important to set the required minimum reaction conditions. When the contact angle to water of the surface of the transparent support opposite to the side having the antireflection structure, i.e., the bonding surface of the antireflection film is used as the index of the damage inflicted on the antireflection layer by alkali, the contact angle is 20 degrees to 50 degrees, preferably 30 degrees to 50 degrees, and more preferably 40 degrees to 50 degrees, particularly in the case where the support is made of triacetyl cellulose. A contact angle of 50 degrees or more is not preferred because it causes a problem with the adhesion to the polarizing film. On the other hand, a contact angle of less than 20 degrees is not preferred because it causes too large damage on the antireflection film, resulting in impairments of the physical strengths and the light resistance.

(2) Alkali Solution Coating Method

As a means for avoiding the damage on the antireflection film with the foregoing dipping method, there is preferably used an alkali solution coating method in which an alkali solution is coated only onto the surface opposite to the surface having the antireflection film, followed by heating, washing with water, and drying, under proper conditions. Incidentally, the coating in this case denotes the operation in which only the side to be subjected to saponification is brought in contact with an alkali solution or the like. At this step, the saponification treatment is preferably carried out so that the contact angle to water of the bonding surface of the antireflection film becomes 10 to 50 degrees. The means further includes, other than coating, spraying, an operation in which the surface is brought in contact with a solution-containing belt or the like, or other operations. By adopting such a method, additional facilities and steps for coating the alkali solution become necessary. For this reason, this method is inferior to the dipping method (1) from the viewpoint of the cost. On the other hand, since the alkali solution comes in contact with only the side to be subjected to a saponification treatment, the opposite surface can have a layer using a material susceptible to an alkali solution. For example, a deposited film or a sol-gel film undergoes various effects such as corrosion, dissolution, or peeling due to an alkali solution, and hence, with the dipping method, it is undesirable that the film is provided. However, with this coating method, the film does not come in contact with the solution, and hence it can be used without any problem.

Either of the saponification methods (1) and (2) can be carried out after unwinding the film from a roll-like support, and forming respective layers, and hence may also be carried out through another series of operations after the foregoing antireflection film manufacturing step. Further, likewise, by continuously carrying out a step of bonding to a polarizing plate comprising the unwound support together, it is possible to form a polarizing plate more efficiently than with the same operation on a per sheet basis.

[Polarizing Plate]

A preferred polarizing plate of the invention has the antireflection film of the invention as at least one of the protective films of the polarizing film (protective film for a polarizing plate). For the protective film for a polarizing plate, as described above, the contact angle to water of the surface of the transparent support opposite to the side having the high refractive index layer, i.e., the surface on the side to be bonded to the polarizing film preferably falls within a range of 20 degrees to 50 degrees.

By using the antireflection film of the invention as the protective film for a polarizing plate, it is possible to manufacture a polarizing plate having excellent physical strengths and light resistance, and an antireflection function. This enables a large cost reduction and a reduction in thickness of a display device.

Whereas, by manufacturing a polarizing plate using the antireflection film of the invention as one of the protective films for a polarizing plate, and an optical compensation film having optical anisotropy described later as the other of the protective films of the polarizing film, it is further possible to manufacture a polarizing plate capable of improving the contrast in a bright room of a liquid crystal display device, and considerably extending the vertical and lateral viewing angles.

[Optical Compensation Layer]

The polarizing plate of the invention can be provided with a film having an optical compensation layer, i.e., an optical compensation film on the surface of the polarizing film opposite to the side thereof on which the antireflection film is provided as a surface protective film.

By using the polarizing plate provided with the film having the optical compensation layer (phase contrast layer) thereon for a liquid crystal display device, it is possible to improve the viewing angle characteristics of the liquid crystal display screen.

As the optical compensation layers, known ones can be used. However, preferred is the optical compensation layer having a layer comprising a compound having a discotic structure unit, and having optical anisotropy, characterized in that the angle formed between the discotic compound and the optical compensation film plane varies inwardly from the optical compensation film surface along the depth direction, described in JP-A-2001-100042.

The angle preferably increases with an increase in distance from the surface of the optical compensation film on the side to be bonded to the polarizing film.

When the optical compensation film is used as the protective film of the polarizing film, the surface on the side to be bonded to the polarizing film has been preferably subjected to a saponification treatment. The treatment is preferably carried out in accordance with the foregoing saponification treatment.

Also preferred are an embodiment in which the optical anisotropic layer further contains cellulose ester, another embodiment in which an orientation layer is formed between the optical anisotropic layer and the transparent support, and a still other embodiment in which the transparent support of the optical compensation layer having the optical anisotropic layer has optically negative uniaxial property, and an optical axis is present in the direction of the normal to the transparent support plane, and further, the following conditions are satisfied.
20≦{(nx+ny)/2−nz}×d≦400

In the above conditional expression, nx denotes the refractive index along the direction of the delayed phase axis (the direction such that the refractive index becomes maximum) in the layer plane; ny, the refractive index along the direction of the advanced phase axis (the direction such that the refractive index becomes minimum) in the layer plane; nz, the refractive index along the thickness direction of the layer; and d, the thickness of the optical compensation layer.

[Image Display Device]

The polarizing plate having an antireflection film is applicable to an image display device such as a liquid crystal display device (LCD) or an electroluminescence display (ELD). For the polarizing plate, the transparent support side of the antireflection film is bonded onto the image display surface.

FIG. 1 shows a preferred embodiment for applying a polarizing plate using an antireflection film as a transparent protective film to an LCD. In FIG. 1, a transparent support (1) of an antireflection film is bonded to a polarizing film (7) via an adhesive layer (6) comprising polyvinyl alcohol, and another protective film (8) of the polarizing film is bonded to the surface of the polarizing film (7) opposite to the surface bonded to the antireflection film via an adhesive layer (6). The polarizing plate has a sticker layer (9) on the surface of the other protective film (8) opposite to the surface bonded to the polarizing film, and bonded directly to, or via another layer, to the glass of a liquid crystal cell of a liquid crystal display device, and used.

The polarizing plate using the antireflection film for use in the invention can be preferably used to a twisted nematic (TN), supertwisted nematic (STN), vertical alignment (VA), in-plane switching (IPS), optically compensated bend cell (OCB), or other mode, transmission type, reflection type, or semi-transmission type liquid crystal display apparatus.

Whereas, when it is used for a transmission type or semi-transmission type liquid crystal display device, it is possible to obtain a display device having a still higher visibility by using a commercially available brightness enhancing film (a polarization separation film having a polarization selection layer, e.g., D-BEF manufactured by Sumitomo 3M, Ltd.) in combination.

Further, by being combined with a λ/4 plate, the polarizing plate can be used as a polarizing plate for a reflection type liquid crystal or a surface protective panel for an organic EL display for reducing reflected light from the surface and the inside.

### EXAMPLES

Below, the invention will be described more specifically by way of examples, which should not be construed at all as limiting the scope of the invention.

### Example 1

(Preparation of Coating Solution for Hard Coat Layer)

To 230 parts by mass of a mixture of dipentaerythritol pentacrylate and dipentaerythritol hexaacrylate (DPHA, manufactured by Nippon Kayaku Co., Ltd.), 76 parts by mass of ethylene oxide-modified trimethylolpropane triacrylate (BISCOAT 360, manufactured by Osaka Organic Chemical Industry, Ltd.), 181 parts by mass of methyl ethyl ketone, 55 parts by mass of cyclohexanone, 8 parts by mass of a photopolymerization initiator (Irgacure 184, manufactured by Ciba-Geigy Japan, Ltd.), and 450 parts by mass of silica sol (MEK-ST, manufactured by NISSAN CHEMICAL INDUSTRIES, Ltd.) were added with stirring. The resulting mixture was filtrated through a filter made of polypropylene with a pore diameter of 0.4 μm to prepare a coating solution for a hard coat layer.

(Preparation of Titanium Dioxide Fine Particle Dispersion)

As titanium dioxide fine particles, titanium dioxide fine particles containing cobalt, and subjected to a surface treatment using aluminum hydroxide and zirconium hydroxide (MPT-129C, manufactured by ISHIHARA SANGYO KAISHA, Ltd., TiO₂:CO₃O₄ Al₂O₃:ZrO₂=90.5:3.0:4.0:0.5 mass ratio) were used.

To 257.1 g of the particles, 38.6 g of the following dispersant, and 704.3 g of cyclohexanone were added, and the resulting mixture was dispersed in a DYNO-Mill to prepare a titanium dioxide dispersion with a mass average diameter of 70 nm. 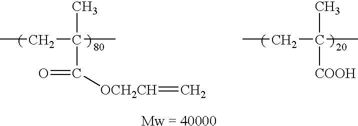
(Preparation of Coating Solution for Intermediate Refractive Index Layer)

To 88.9 g of the aforesaid titanium dioxide dispersion, 58.4 g of a mixture of dipentaerythritol pentacrylate and dipentaerythritol hexaacrylate (DPHA, manufactured by Nippon Kayaku Co., Ltd.), 3.1 g of a photopolymerization initiator (Irgacure 907, manufactured by Ciba Speciality Chemicals, Ltd.), 1.1 g of photosensitizer (KAYACURE-DETX, manufactured by Nippon Kayaku Co., Ltd.), 482.4 g of methyl ethyl ketone, and 1869.8 g of cyclohexanone were added with stirring. After sufficient stirring, the resulting mixture was filtrated through a filter made of polypropylene with a pore diameter of 0.4 μm to prepare a coating solution for an intermediate refractive index layer.

(Preparation of Coating Solution for High Refractive Index Layer)

To 586.8 g of the aforesaid titanium dioxide dispersion, 47.9 g of a mixture of dipentaerythritol pentacrylate and dipentaerythritol hexaacrylate (DPHA, manufactured by Nippon Kayaku Co., Ltd.), 4.0 g of a photopolymerization initiator (Irgacure 907, manufactured by Ciba-Geigy, Japan, Ltd.), 1.3 g of photosensitizer (KAYACURE-DETX, manufactured by Nippon Kayaku Co., Ltd.), 455.8 g of methyl ethyl ketone, and 1427.8 g of cyclohexanone were added with stirring. The resulting mixture was filtrated through a filter made of polypropylene with a pore diameter of 0.4 μm to prepare a coating solution for a high refractive index layer.

(Preparation of Coating Solution for Low Refractive Index Layer)

A copolymer (P-1) in accordance with the invention was dissolved in methyl isobutyl ketone in a concentration of 7 mass %. To the resulting solution, a terminal methacrylate group-containing silicone resin X-22-164C (manufactured by Shin-Etsu Chemical Co., Ltd.) was added in an amount of 3% based on the solid content, and a photoradical generator Irgacure 907 (trade name) in an amount of 5 mass % based on the solid content. After sufficient stirring, the resulting mixture was filtrated through a filter made of Teflon with a pore diameter of 0.45 μm (absolute filtration diameter) to prepare a coating solution for a low refractive index layer.

(Preparation of Antireflection Film 1)

On a 80 μm-thick triacetyl cellulose film (TD-80UF, manufactured by Fuji Photo Film, Co., Ltd.), the coating solution for a hard coat layer was applied using a micro gravure coater. After drying at 90° C., UV radiation with an illuminance of 400 mW/cm², and an exposure dose of 350 mJ/cm² was applied thereto using a 160 W/cm air cooled metal halide lamp (manufactured by EYEGRAPHICS Co., Ltd.) while carrying out nitrogen purge so as to achieve an atmosphere with an oxygen concentration of 1.0% by volume or less. As a result, the coated layer was cured to form a 4.9 μm-thick hard coat layer.

Onto the hard coat layer, the coating solution for an intermediate refractive index layer, the coating solution for a high refractive index layer, and the coating solution for a low refractive index layer were continuously applied by means of a micro gravure coater having 3 coating stations.

The drying conditions of the intermediate refractive index layer were set at 100° C. and 30 seconds. The UV radiation curing conditions were set as follows: while carrying out nitrogen purge so as to achieve an atmosphere with an oxygen concentration of 0.5% by volume or less, an illuminance of 400 mW/cm² and an exposure dose of 350 mJ/cm² were set using a 180 W/cm air cooled metal halide lamp (manufactured by EYEGRAPHICS Co., Ltd.).

The intermediate refractive index layer after curing had a refractive index of 1.630 and a film thickness of 67 nm.

The drying conditions of the high refractive index layer were set at 100° C. and 30 seconds. The UV radiation curing conditions were set as follows: while carrying out nitrogen purge so as to achieve an atmosphere with an oxygen concentration of 0.5% by volume or less, an illuminance of 500 mW/cm² and an exposure dose of 500 mJ/cm² were set using a 240 W/cm air cooled metal halide lamp (manufactured by EYEGRAPHICS Co., Ltd.).

The high refractive index layer after curing had a refractive index of 1.905 and a film thickness of 107 nm.

The drying conditions of the low refractive index layer were set at 90° C. and 30 seconds. The UV radiation curing conditions were set as follows: while carrying out nitrogen purge so as to achieve an atmosphere with an oxygen concentration of 0.5% by volume or less, an illuminance of 500 mW/cm² and an exposure dose of 1000 mJ/cm² were set using two 240 W/cm air cooled metal halide lamps (manufactured by EYEGRAPHICS Co., Ltd.).

The low refractive index layer after curing had a refractive index of 1.440 and a film thickness of 83 nm.

Thus, an antireflection film 1 was manufactured.

(Preparation of Antireflection Film Sample 2)

Further, in the process for manufacturing the antireflection film sample 1, the titanium dioxide particles used for the intermediate refractive index layer and the high refractive index layer were changed to titanium dioxide fine particles subjected to a surface treatment using aluminum hydroxide (TTO-55B, manufactured by ISHIHARA SANGYO KAISHA, Ltd., TiO₂:Al₂O₃=92.0:8.0 mass ratio) for use, thereby to manufacture an antireflection film 2.

(Manufacturing of Polarizing Plate)

Under the conditions shown in Table 1, the resulting antireflection films were subjected to respective treatments different in degree of the saponification reaction, and sufficiently washed with water. Then, each film was neutralized in a dilute sulfuric acid aqueous solution, and then further washed with water sufficiently. Thereafter, the film was sufficiently dried at 100° C., resulting in a protective film for a polarizing plate.

A 75 μm-thick polyvinyl alcohol film (manufactured by Kuraray Co., Ltd.) was dipped in an aqueous solution comprising 1000 parts by mass of water, 7 parts by mass of iodine, and 105 parts by mass of potassium iodide, and allowed to adsorb iodine. Then, the film was uniaxially drawn to 4.4 times its original length in a 4 mass % boric acid aqueous solution, and then dried still in a stretched form, thereby to manufacture a polarizing film.

Using a polyvinyl alcohol type adhesive as an adhesive, the triacetyl cellulose side of the antireflection film (surface protective film for a polarizing plate), subjected to a saponification treatment, was bonded to one surface of the polarizing film. Further, to the other side of the polarizing film, a triacetyl cellulose film, which had been subjected to a saponification treatment in the same manner as with the Example sample 1 in Table 1, was bonded using the same polyvinyl alcohol type adhesive.

TABLE 1

| | Anti- | | | Alkali | |
|---|---|---|---|---|---|
| | reflection | Alkali | | solution | Treatment |
| Sample | film | species | Normality | temperature | time |
| Example | 1 | NaOH | 1.5 mol/l | 55° C. | 100 sec |
| sample 1 | | | | | |
| Example | 1 | NaOH | 1.5 mol/l | 55° C. | 60 sec |
| sample 2 | | | | | |
| Example | 1 | NaOH | 1.5 mol/l | 55° C. | 15 sec |
| sample 3 | | | | | |
| Example | 1 | NaOH | 1.5 mol/l | 40° C. | 30 sec |
| sample 4 | | | | | |
| Example | 1 | NaOH | 1.5 mol/l | 35° C. | 60 sec |
| sample 5 | | | | | |
| Example | 1 | NaOH | 2.5 mol/l | 70° C. | 15 sec |
| sample 6 | | | | | |
| Example | 1 | NaOH | 2.5 mol/l | 70° C. | 30 sec |
| sample 7 | | | | | |
| Comparative | 1 | NaOH | 1.5 mol/l | 55° C. | 180 sec |
| Example | | | | | |
| sample 1 | | | | | |
| Comparative | 2 | NaOH | 1.5 mol/l | 55° C. | 180 sec |
| Example | | | | | |
| sample 2 | | | | | |

(Evaluation of Antireflection Surface of Polarizing Plate)

The antireflection film side of each polarizing plate manufactured was evaluated for the following respective items. The contact angle to water of the surface of each sample in Table 1 opposite to the side having the antireflection film and the evaluation results are shown in Table 2.

(1) Steel Wool Rubbing

Each sample was rubbed for 10 reciprocations under a load of 200 g by steel wool of #0000, and how each sample had been scratched was evaluated based on the following criteria:

⊚: Not scratched at all;

∘: Slightly scratched, but not noticeable;

Δ: Scratched, but low refractive index layer is left; and

x: Totally scratched

(2) Pencil Scratch Test

The pencil scratch test described in JIS K 5400 was carried out. The antireflection film was humidity controlled at a temperature of 25° C. and at a humidity of 60% RH for 2 hours. Then, the hardness of the pencil highest in hardness by which no scratch was observable at all, or one or less scratch was observable in evaluation of n=5 using the pencil for test specified in JIS S 6006, under a load of 500 g, was taken as the pencil hardness.

(3) Evaluation of Weather Resistances

By the use of a xenon arc lamp type weather resistance tester (XF model) adjusted to outdoor mean sunlight conditions by a borosilicate glass filter and a quartz filter, weather resistance tests at respective levels of an exposure time of 0 hour, 300 hours, 600 hours, and 900 hours were carried out at an illuminated surface illuminance of 80 klux and a blackbody temperature of 63° C. in an atmosphere of a relative humidity of 50%.

Each polarizing plate after exposure was moisture controlled for 2 hours under the conditions of a temperature of 25° C. and a relative humidity of 60%.

On the surface of each polarizing plate on the side having an antireflection film, 11 vertical cuts and 11 horizontal cuts were incised in a grid pattern by a cutter knife to cut a total of 100 squares. A polyester sticky tape (No. 31B) manufactured by Nitto Denko Co., Ltd., was attached thereto by pressure, so that an adhesion test was performed at the same site, repeatedly, 3 times. The occurrence or non-occurrence of peeling was visually observed, and the evaluation based on the following 1-to-4 scale was carried out.

⊚: The one in which no peeling was observed at all in the 100 squares;

∘: The one in which peeling was observed in two or less squares out of the 100 squares;

Δ: The one in which peeling was observed in 3 to 10 squares out of the 100 squares; and

x: The one in which peeling was observed in more than 10 squares out of the 100 squares

TABLE 2

| | Contact | Steel | | Evaluation |
|---|---|---|---|---|
| | angle to | wool | Pencil | of weather |
| Sample | water | rubbing | hardness | resistances |
| Example | 26 degrees | ◯ | 3H | ⊚ |
| sample 1 | | | | |
| Example | 30 degrees | ◯ | 3H | ⊚ |
| sample 2 | | | | |
| Example | 46 degrees | ⊚ | 3H | ⊚ |
| sample 3 | | | | |
| Example | 46 degrees | ⊚ | 3H | ⊚ |
| sample 4 | | | | |
| Example | 39 degrees | ⊚ | 3H | ⊚ |
| sample 5 | | | | |
| Example | 28 degrees | ◯ | 3H | ⊚ |
| sample 6 | | | | |
| Example | 29 degrees | ◯ | 3H | ⊚ |
| sample 7 | | | | |
| Comparative | 19 degrees | Δ | H | Δ |
| Example | | | | |
| sample 1 | | | | |
| Comparative | 19 degrees | X | 2B | X |
| Example | | | | |
| sample 2 | | | | |

Table 2 indicates that the polarizing plate in accordance with the invention can implement excellent physical strengths and weather resistances.

### Example 2

(Evaluation of Image Display Device)

A TN liquid crystal display device mounting thereon the polarizing plate of the invention thus manufactured was excellent in antireflection performance and very excellent in visibility.

### Example 3

(Manufacturing of Viewing Angle Enlarging Polarizing Plate)

The surface of an optical compensation film (Wide View Film SA-12B, manufactured by Fuji Photo Film, Co., Ltd.) having an optical compensation layer in which the disc plane of the discotic structure unit is inclined to the transparent support plane, and the angle formed between the disc plane of the discotic structure unit and the transparent support plane varies in the direction of depth of an optical anisotropic layer was subjected to a saponification treatment by a dipping method under the same conditions as for the film 1 of Example 1. The optical compensation layer side of the optical compensation film subjected to the saponification treatment was bonded in place of the saponified triacetyl cellulose in the polarizing plate 1 of Example 1 using the same polyvinyl alcohol type adhesive. As a result, a viewing angle enlarging polarizing plate of which both the surfaces were protected by the antireflection film and the optical compensation film was formed.

(Evaluation of Image Display Device)

A liquid crystal display device manufactured by bonding the optical compensation layer side of the polarizing plate thus manufactured on the glass surface on the viewing side of a transmission type TN cell was more excellent in contrast in a bright room than with a liquid crystal display device mounting thereon a polarizing plate not using an optical compensation film, and has very wide vertical and lateral viewing angles, and further excellent in antireflection performance and very excellent in visibility and display quality.

Whereas, to a STN, IPS, VA, or OCB mode transmission type, reflection type, or semi-transmission type liquid crystal display device, the antireflection film of the invention is applicable when a proper phase contrast film is used, if required, between the polarizing plate on the viewing side and a liquid crystal-filled glass cell, or as a film on the liquid crystal cell side of two protective films forming a polarizing plate on the viewing side. As a result, it is possible to improve the visibility in each mode display device.

This application is based on Japanese Patent application JP 2003-91770, filed Mar. 28, 2003, and Japanese Patent application JP 2003-341323, filed Sep. 30, 2003, the entire contents of those are hereby incorporated by reference, the same as if set forth at length.

1. A method for manufacturing a polarizing plate comprising: bonding an antireflection film containing a transparent support and an antireflection structure including a plurality of layers different in refractive index each comprising a cured film to a polarizing film, wherein at least one layer of the plurality of layers different in refractive index is a layer having a higher refractive index than that of the transparent support and a thickness of 10 nm to 2 μm, and the antireflection film is bonded to the polarizing film after being subjected to a hydrophilization treatment so that a contact angle to water of a surface of the antireflection film to be bonded to the polarizing film falls within a range of 20 degrees to 50 degrees.

2. The method according to claim 1, wherein the hydrophilization treatment includes a step of dipping the antireflection film in an alkali solution for saponification.

3. A method for manufacturing a polarizing plate comprising: bonding an antireflection film containing a transparent support and an antireflection structure including a plurality of layers different in refractive index each comprising a cured film to a polarizing film, wherein a surface of the antireflection film opposite to a surface thereof on which the antireflection structure is formed is taken as a bonding surface to the polarizing film, and only the bonding surface is subjected to a saponification treatment so that a contact angle to water falls within a range of 10 degrees to 50 degrees.

4. The method according to claim 1, wherein the cured film is obtained by coating, drying, and curing a coating composition containing at least one film-formable solute and at least one solvent.

5. The method according to claim 3, wherein the cured film is obtained by coating, drying, and curing a coating composition containing at least one film-formable solute and at least one solvent.

6. The method according to claim 1, wherein at least one of the plurality of layers different in refractive index contains inorganic particles.

7. The method according to claim 3, wherein at least one of the plurality of layers different in refractive index contains inorganic particles.

8. The method according to claim 6, wherein the plurality of layers different in refractive index include at least one high refractive index layer having a higher refractive index than that of the support and at least one low refractive index layer having a lower refractive index than that of the support, and the high refractive index layer has a refractive index of 1.55 to 2.40 and contains inorganic particles containing titanium dioxide and at least one element selected from cobalt, aluminum, and zirconium.

9. The method according to claim 7, wherein the plurality of layers different in refractive index include at least one high refractive index layer having a higher refractive index than that of the support and at least one low refractive index layer having a lower refractive index than that of the support, and the high refractive index layer has a refractive index of 1.55 to 2.40 and contains inorganic particles containing titanium dioxide and at least one element selected from cobalt, aluminum, and zirconium.

10. The method according to claim 8, wherein each of the inorganic particles is covered with at least one compound of an inorganic compound, an organometallic compound, and an organic compound, which reduces or destroys a photocatalytic activity.

11. The method according to claim 9, wherein each of the inorganic particles is covered with at least one compound of an inorganic compound, an organometallic compound, and an organic compound, which reduces or destroys a photocatalytic activity.

12. A polarizing plate which is manufactured by the manufacturing method according to claim 1.

13. A polarizing plate which is manufactured by the manufacturing method according to claim 3.

14. The polarizing plate according to claim 12, wherein the polarizing plate comprises a plurality of surface protective films including the antireflection film; a film other than the antireflection film included in the plurality of surface protective films is an optical compensation film which contains an optical compensation layer containing an optical anisotropic layer provided at a side of the optical compensation film, the side being opposite to a side thereof to be bonded to the polarizing film; the optical anisotropic layer is a layer having a negative birefringence, and containing a compound having a discotic structure unit, a disc plane of the discotic structure unit is inclined to a plane of the surface protective film, and an angle formed between the disc plane of the discotic structure unit and the plane of the surface protective film varies in a direction of depth of the optical anisotropic layer.

15. The polarizing plate according to claim 13, wherein the polarizing plate comprises a plurality of surface protective films including the antireflection film; a film other than the antireflection film included in the plurality of surface protective films is an optical compensation film which contains an optical compensation layer containing an optical anisotropic layer provided at a side of the optical compensation film, the side being opposite to a side thereof to be bonded to the polarizing film; the optical anisotropic layer is a layer having a negative birefringence, and containing a compound having a discotic structure unit, a disc plane of the discotic structure unit is inclined to a plane of the surface protective film, and an angle formed between the disc plane of the discotic structure unit and the plane of the surface protective film varies in a direction of depth of the optical anisotropic layer.

16. A liquid crystal display device containing the polarizing plate according to claim 12.

17. A liquid crystal display device containing the polarizing plate according to claim 13.
